(19) United States
(12) Patent Application Publication
(10) Pub. No.: US 2016/0187891 A1
(43) Pub. Date: Jun. 30, 2016

(54) Hydrostatic Pressure Exchanger

(71) Applicant: Thomas Michael Reilly, Kendall Park, NJ (US)

(72) Inventor: Thomas Michael Reilly, Kendall Park, NJ (US)

(21) Appl. No.: 14/586,719

(22) Filed: Dec. 30, 2014

(51) Int. Cl. G05D 7/06; G05B 15/02

(52) U.S. Cl. CPC G05D 7/0676; G05B 15/02

(57) ABSTRACT

The Hydrostatic Pressure Exchanger transforms a volume of water and its energy potential collectively referred to as hydrostatic pressure into a natural, harmless, spontaneous, and limitless energy source. That Available Energy may be applied to electrical generators, compressors, pumps, mechanical transmissions, and other producers for a useful result. The abundance of water around the world allows the Exchanger to provide Available Energy to communities across the world near oceans, seas, bays, lakes, or other natural and man-made bodies of water or flowing water. The Exchanger is a Vessel divided by a Slider into two Chambers. By the synchronized action of InPorts and OutPorts the Slider moves away from the Chamber opened to the higher hydrostatic pressure of the volume of water and towards the Chamber of lower hydrostatic pressure defined by Chamber dimensions. As the Slider moves it pushes water in the Chamber through the OutPort at useful higher velocity and pressure.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### Field of the Invention

Disclosed is a hydrostatic pressure to accelerated velocity and higher pressure flow Exchanger as a Available Energy source to power electric generators, compressors, pumps, clutches and transmissions, and other devices requiring an external force.

### PROBLEM STATEMENT

There is continued and growing concern about a lack of available and sustainable energy from all energy sources. Electricity is a dominate form of energy produced because of its versatility, current infrastructure, tailorability, and many other favorable properties. The production of electricity is currently dominated by hydraulic energy conversion, carbon based thermal energy conversion, and nuclear thermal energy conversion.

Electric production from hydraulic power is the most significant source of energy. The building cycle is usually a decade with the best scale of hydroelectric power station normally being 1,000,000 kWh. A conversion rate from hydraulic fluid power to electric power rate is about 40 to 60%. There is no pollution from this process of power generation. The cost of power generation is also lower than that of other methods. Hydroelectric power generation uses the natural fluid flow from rivers natural waterfalls, but natural flowing water sources suitable for energy production are rare. Man-made structures such as water chutes and dams are an alternative to natural water flows and can come with multiple uses and concerns. Dams are expensive to build and maintain, require flooding large areas of land behind them which displaces people and wildlife, may destroy cultural and ancestral sites, and often removes the most fertile land from agricultural uses. A dam failure often causes great destruction and loss of life. Most Importantly at this time, suitable locations for dams are already being utilized and there is increasing societal concern about dams resulting in stringent new construction and even destruction requirements.

Carbon based thermal power generation is a significant contributor to electrical energy supply. The normal building cycle is 3 to 5 years with 10 years for the larger scale thermal power stations. The best scale of a thermal power station is 60 kW per hour. The energy conversion rate of thermal power station is normally 35%. Most thermal power is derived from burning coal with a few plants burning oil or gas as fuel. Although the efficiency of burning carbon based fuel has increased dramatically over the years, the debate over the availability and sustainability of coal, oils, and gas resources, as well as their environmental impact carbon based emissions is getting louder. Rising costs of these resources makes their cost greater than that of liquid power station and slightly lower than that of nuclear power station.

Thermal nuclear power generation can be a significant and even sole power source to a community in it proximity, but overall thermal nuclear power has not been permitted to make the contribution of which it is capable. The building cycle of nuclear power station is longer than that of thermal power plant and shorter than that of hydroelectric power. The nuclear power conversion rate is about 40%. These power generating plants mainly use scarce and radioactive uranium nuclear fission for thermal generation. To avoid nuclear leakage specialized equipment is required in the plant and for the storage of spent nuclear materials with the combined costs of these systems and procedures making power generation more costly than that of the other methods of powers generation. No harmful environmental emissions result from a properly operating thermal nuclear plant. The social concerns and resource constraints on this method of power generation also call for alternatives.

Although thermal and hydraulic power production have served us well and will continue to serve society well for years to come, the growing limitations and disadvantages of these sources of energy are becoming more evident to societies worldwide. Further, as societies continue to flourish and advance, the demand for power generation continues to increase. Additionally, this growing demand increasingly strains current energy capability and cannot always be met by new, costly, sophisticated, and efficient dams and hydroelectric, thermal nuclear power, or carbon thermal power plants. The strain is further exasperated often by insufficient local sources of flowing water, coal or other carbon forms, nuclear resources and/orexpertise. Furthermore societal constraints may not make them practical to expand. It is further unacceptable in modern society to experience brown-outs or reduced power periods, rationing, escalating costs, and other hardships that occur to the health and welfare of individuals, families, societies and economies.

The solution is seeking meaningful energy alternatives. To date alternatives have surfaced, but have proven inadequate in contributing to the magnitude needed to be a replacement energy source to thermal and fluid power. At present there are small size power stations using wind energy, solar energy, geothermal, and alternative carbon based facilities. Even the most meaningful alternatives create only a negligible amount of energy production. They also suffer from location constraints, resource constraints, and can be intermittent such as with consistent wind and sun that can be dependent upon seasonal, time of day, weather, or other factors. Given these factors and usual energy conversion rates as low as 10%, the high investment costs can be too unpredictable and lengthy for a return on investment.

When looking to natural forces from which to convert a useful source of energy, it becomes immediately apparent that that two sources of naturally occurring energy phenomenon remain countless and limitless. Two such are gravity due to the mass of the earth and hydrostatic pressure due to the mass of water. Ironically gravitational and hydrostatic forces and powers generated from them are some of the oldest known and consistent sources of energy use throughout civilization. Of these the dominant accessible resource on the earth is water. Water covers three-fourths of the earth's surface from a combination of oceans, seas, bays, and large to small internal bodies of inland water including man-made dams and reservoirs. There are numerous sources of flowing water but in total these remain small in comparison to stationary water.

Recognizing the abundance and favorability of water as a source of energy has created a general movement in developing alternative energy captured or converted from the different characteristics associated with water. Water has a useable mass that creates a source of energy from water flow and water at elevation. As mentioned previously many of the most favorable or suitable locations for capturing energy from the flow of surface water have already been used and are therefore limited. Development is now moving towards exploring the energy capture or created by the movement of water from tidal or wave action and deep water currents. In many cases each of these are subject to astrological and climatologically conditions of time of season and time of day for tidal action, wind and sun consistency, and precipitation, as well as some influences upon ocean current change making the energy results of these attempts variable and unreliable.

What about stationary water that hold potential energy from the mass of water and gravitational forces upon it? This is an important area of development as non-flowing water is found across the majority of the earth in oceans, seas, bays, and inland lakes, dams, and reservoirs. Further, the United Nations at the time of this application publishes that 40% of the global populations lives within 100 kilometers of the coast, and 44% within 150 kilometers. The potential energy of a cubic meter volume of water is the constantly exertion of 62.42796 pounds of pressure per cubic foot or a cubic meter weighing about 1 ton. A column of water 1 ft.² at a depth of 100 feet exerts a pressure at its base of 6242 pounds of pressure (three tons). The same column of water at 500 feet would exert nearly 16 tons of pressure at its base. As the cross-sectional area expands from 1 foot to larger dimensions, the area of pressure exerted increases with the surface area of the column of water.

The Exchanger focuses upon energy available from a volume of water that remains underutilized and in such favorable proximity to social need. Quiescent water, below surface stationary water, and even deep water properties provide environmental conditions that are relatively constant, favorable, and largely independent of astrological and climatologically conditions. Although not a focus of the Exchanger, its simplicity and adaptability do allows for its use with flowing, moving, or surface water.

A self-contained system would also be developed requiring its own reservoir. This system would be scalable to create large systems generating significant energy to personal size systems that could sit in a garage or basement to supplement a home's power or use as emergency backup. The lack of pollutants or fossil fuels makes this feasible for home use.

### STATE OF THE ART ASSESSMENT

An assessment of the state of converting the latent energy found in stationary or a volume of water to a Available Energy form was undertaken. The following US patents and patent applications pertaining to energy generation from a volume of water are reviewed. This eliminates a comparison to devices that attempt to create a useful force or energy from flowing water and surface water that is often variable and unreliable as previously mentioned. It is noted that generally the citations do not match the simplicity and scalability of the Exchanger for deployment potential to communities across the world. The following citations also do not provide access to as many opportunities to extract energy from the hydrostatic pressure water or a fluid. The Exchanger provides novel and non-obvious advancements in energy extraction from water.

Application Pub No. US2012/0049673 A1 to Myung Hoe Koo seeks to convert stationary water to a Available Energy source by disclosing a device of a cylinder divided in half. Each have of the cylinder has a cylinder plate lifted and lowered by an electric motor, and utilizes solar panels and storage battery to drive the electric motor. Water enters the system through one-way valves in the cylinder plates prior to the plate dropping to the bottom of the cylinder and forcing water through an electric generator. The numerous systems of the Koo disclosure make it impractical for broad worldwide use. The Exchanger seeks to minimize components such as the requirement of lifting heavy gravity plates and seeks a more energy neutral device to produce a working force that can be coupled to electric generators, compressors, pumps, and mechanical systems, and other useful devices to society.

U.S. Pat. No. 8,796,870 B2 to Wai Hing Cheung seeks to convert stationary water to a Available Energy source by disclosing the use of two water cylinders depicted as two high columns with two movable Chambers traveling up and down within the two water tanks. Required is the use of electromagnetic devices for holding and releasing Chambers that act under gravity and act in concert with buoyant components to create a cyclical movement to drive an electric motor to generate electric power. The Cheung Generator requires a complex mechanism, gravitational and buoyancy forces, electromagnetism, lifting and holding chains, and so forth with many Elements being energy consuming. This mechanism is fails the goals of the Exchanger to approach energy neutrality and to be a simple device operational in locations and cultures worldwide to create a force for energy or other useful purposes.

Application Pub No. US 2014/0191509 A1 to David Stauffer seeks to convert stationary water to a Available Energy source by gravity and siphon action. The core principle of this disclosure is water flowing through a pipe held below the surface of stationary water that drops some distance to a bend, across a horizontal section, and then through an upward opening to terminate in an air bubble held by in place by a Container. Although the Stauffer device is generally simple, it only relies upon the motion of falling water and siphoning, and must address the phenomenon, dynamics, and maintenance of water entering an air pocket exerting equal pressure as the surrounding external body of water. The exchange addresses these phenomenological issues by relying upon the principles of constant volume flow between different Vessel Conduit sizes to force an increased velocity and pressure of water eliminating integral components of the Stauffer device.

Application Pub No. US 2010/0084866 A1 to Todd Smith seeks to convert stationary water to a Available Energy source by a combination of hydrostatic pressure and gravity. The core disclosure principle requires that “a piston may weigh less than the weight or force of the external water pressure so that the internal piston will move upward. The internal piston should also however weigh more than the weight of the water under it. As gravity acts on the internal piston pulling it down is gravitational force is greater than the water weight it is expelled through the water exit line. Without the weight of the internal piston the water in the main housing would be at equilibrium and would not move.” The Smith device is a brute force mechanism seeking overwhelming hydrostatic pressures from very deep water positioning, overwhelming component mass for sufficient gravitational force, collection tanks, vacuum systems, large infrastructure, and more. Needed is a simplified and more versatile force generator more available for use in large and smaller stationary bodies of water, potentially closer to areas of need.

Application Pub No. US 2013/0089410 A1 to Chris Azar seeks to convert stationary water to a Available Energy source by disclosing the use of an inner and outer tube designed to selectively contain and distribute a water flow with the core principle of water falling through an atmosphere onto generators. The system is maintained with a number of different pumps being used at the bottom of the inner tube to maintain water levels and water flow within the system. The Azar disclosure is another example of a complex system requiring significant infrastructure and energy consumption. In total it fails to meet the objectives of this disclosure for simplicity and utility across all cultures and locations with a modest body or water or flowing water.

U.S. Pat. No. 8,146,361 B2 to Jifan Jin and Application Pub No. US 2011/0012369 A1 to Kurt Grossman each seek to convert stationary water to an Available Energy source by disclosing submerged devices centered on Containers loaded with water and falling through an atmospheric environment using gravity and mass as the driving force. Described is an elaborate method using cabling system or lever system to cycling mass and gravity from one Container to the other. Each of these devices requires not only the actuating device, but large infrastructures. Although the Jin Grossman devices may achieve its purpose, the Exchanger seeks to more directly harness the endless potential energy of hydrostatic pressure from stationary water mass and gravity forces.

Application Pub No. US 2011/0011086 A1 to Anthony Megaro and Application Pub No. US 2013/0081535 A1 to Stefanos Ntoukolianos each seek to convert stationary water to a Available Energy source by disclosing submerged devices centered on Containers loaded with water and acting on a rotary crankshaft structure. In the former case the water is acting downward under gravity and water mass, and in the later the system is acting under more of a hydrostatic pressure driving force. Although these devices may achieve their purpose, the current disclosure seeks a more simplified, scalable, and accessible Exchanger to more directly harness the endless potential energy of hydrostatic pressure from stationary water mass and gravity forces.

The above review expresses that the current state of the art of converting stationary or a volume of water into a useful mechanical motion or fluid flow is filled with complexity and energy consuming components whether energy using motors, friction suffering mechanical components, and often significant infrastructure. The purpose of the current disclosure is the creation of a simple, scalable, and minimal component engine fueled by endless sources of energy stored in gravitational force and the mass of water combined and expressed in the form of useful hydrostatic water pressure derived from a body of water or other fluid. The current disclosure makes possible the creation of energy by conversion of hydrostatic water pressure into energy derived from mechanical and fluid motion that can be used to drive electric generators, compressors, pumps, mechanical transmissions, and other useful purposes. The Exchanger makes useful magnitudes of energy attainable and applicable to any area of modest stationary water, or even flowing water, for the benefit of people in largely all parts of the globe.

The above review is not admitted to describe or constitute pertinent prior art to the conversion of hydrostatic pressure to energy derived from mechanical or fluid motion disclosed in the present application, or consider any cited documents material to the patentability of the claims of the present application.

### SUMMARY OF THE INVENTION

Given the abundance of water on earth, it is natural to turn to water for its potential as an energy source. Previously summarized is energy derived from the use of flowing water and the lack of further favorable natural or man-made sites for energy production from flowing water. Recognized is the need to access the vast energy potential stored in the abundant sources of stationary water or water held in a volume.

The potential energy of water results from many physical properties of a volume of water, but here this potential is largely ascribed to the mass of the water and gravitational forces upon, and collectively termed as hydrostatic pressure. Hydrostatic pressure is commonly defined as the pressure exerted by a fluid at equilibrium at a given point within the fluid, due to the force of gravity. A property of hydrostatic pressure is that it increases in proportion to depth measured from the surface because of the increasing weight of fluid exerting downward force from above. The definition of hydrostatic pressure includes properties of any fluid. This disclosure will focus and refer to water as the likely fluid of use, but the Exchanger is operable with a wide range of fluids used for various specific purposes, such as anti-bacterial, viscosity choices, thermal properties, and more. Hydrostatic pressure will be inclusive of all forces within a volume of water that will be used to draw Available Energy that is spontaneously formed, harmless, renewable, and endless. When such potential energy or force exists, then there is the potential to extract it through Flow, Motion, and their combination and exchange this hydrostatic pressure into useful purposes.

The Exchanger transforms a volume of water to water Flow, mechanical Motion, or their combination by comprising a Vessel, with a Slider containing two Slider Surfaces held in position by a Slider Link that divides the Vessel into two Chambers. Each Chamber controls its internal environment through In Ports and OutPorts at opposing ends to the other Chamber by which are opened and closed by Actuators and related systems.

The result of the combination of Exchanger Elements is the Slider being substantially sealed and moving across one Chamber and then the other powered by Actuators opening and closing InPorts and OutPorts. A useful sequence of openings and closings creates a higher hydrostatic pressure in one Chamber from exposure to external larger water volumes and closure of the opposing Chamber to contain a lower hydrostatic pressure water volume defined by the smaller Chamber dimensions and protection from external forces. As the Chambers alternate between higher hydrostatic pressure and lower hydrostatic pressure the Slider moves in response to the lower hydrostatic pressure side and pushing the water in the lower hydrostatic pressure side out of the Chamber as the opposing Chamber fills. The result is water passing through the OutPort being accelerated to higher velocity and pressure than water moving in the Chambers due to continuity of volume flow. With a Slider Link that passes through a Vessel Conduit; and

The resulting water movement and flow is available to Converter to create an energy product. Where a mechanical movement is created in the Exchanger with a Slider Link passing through a Vessel Conduit and Extractor retrieved the motion to make available Available Energy Sites for Converters to create Useful Energy. Converters are electrical generators, compressors, pumps, mechanical transmissions, or other device that create Useful Energy. The Exchanger is type of water engine driven by hydrostatic pressure to create useable energy from bodies and flows of water around the world. Its simplicity, scalability to need, and hence affordability make energy available to communities at meaningful magnitudes. The Exchanger may be more fully understood by reference to the following drawings.

### BRIEF DESCRIPTION OF THE SEVERAL VIEWS OF THE DRAWING

FIG. 1 An internal view of a linear Exchanger configuration for submerged application having the potential for longer Slider travel to reduce the reciprocal and cyclic operation characteristics; and also shows Converter action with either movement of the Slider.

FIG. 2 An internal view of an adjacent Chamber Exchanger configuration with Vessel and Container suitable for submerged, semi-submerged, and non-submerged applications, and also having a Vessel Conduit between the Chambers where the Slider Link can be accessed for additional energy extraction.

FIG. 3 Slider configuration examples showing the two Slider Surfaces and Slider Link in the form or a homogeneous unit or having links composed of flexible solids, gels, semi-solids, fluid, solutions, compressed gases, or mechanical systems for operating through the Vessel Conduit between the Chambers.

FIG. 4 InPort configuration examples constructed to restrain external hydrostatic pressure from the Chamber internal environment, as well as constructed to open and close to access water flow and that same higher hydrostatic pressure as a source of energy acting on the Exchanger.

FIG. 5 An internal left side view of FIG. 2 Exchanger with Vessel and Container and showing Vessel Conduit Pulley and Axle energy Extractor from the Slider Link and InPort and OutPort Actuators.

FIG. 6 An internal view of an adjacent Chamber Exchanger similar to FIG. 2 but distinguished by showing only the Vessel and teaching a different large Pulley diameter with Axle Extractor of energy from the Slider Link movement through the Vessel Conduit.

FIG. 7 An external view of an adjacent Chamber Exchanger similar to FIG. 2 but distinguished by with Vessel and tall Container structure for higher hydrostatic pressure, and additionally showing optional configuration alterations of multiple energy Converters associated with InPort water flow, OutPort water flow, and an Extractor of Slider movement at the Vessel Conduit, and with the Axle having a momentum wheel.

FIG. 8 An internal view of energy Extractors with one configuration showing a Vessel Conduit between two Chambers with a “paddle wheel” type Extractor with accelerated flow restriction; and a second Extractor show to be positioned in the Container to capture water flow above and into the In Port, with each creating an Axle or Energy Site for a Converter to access the useable source of energy for a useful purpose.

FIG. 9 An internal view showing possible integration of third party cartoon views of Converters that create energy in a useful form by direct conversion of fluid or water flow through the Converters integrated in the Vessel Conduit between Chambers or through Converters integrated in the Chamber or between the Chamber and the InPorts.

FIG. 10 An internal view of a linear Exchanger with a horizontal Vessel of potentially long length divided by a Slider into two Chambers and having a Container of potentially long vertical height, with InPorts and OutPorts to control Chamber hydrostatic pressure and water flows.

FIG. 11 An external view of the left side of FIG. 10 teaching another configure variation of the Exchanger with a Vessel with a potentially tall vertical Container suitable for submerged, semi-submerged, and non-submerged application; Actuators to control InPorts and OutPorts; and a Converter exhausting through an OutPort Return to the Container.

FIG. 12 An internal view of FIG. 10 Exchanger Vessel, but without the Container for submerged application and teaching of configuration variability while retaining key functional Elements of a Slider dividing the Vessel into two Chambers and InPorts and OutPorts synchronized for alternating higher and lower hydrostatic pressure between the Chambers to move the Slider from one side to the other to exchange higher hydrostatic pressure to water flow at accelerated velocity and higher pressure to create sources of energy for useful purposes. Incorporates windings and a Slider with magnetic properties for electrical generation.

FIG. 13 An external side view of FIG. 12 horizontal Exchanger with Container, showing another configuration within what is claimed, but distinguished by with a Container structure for submerged, semi-submerged, and non-submerged applications, and additionally showing InPort and OutPort Actuators and Converter.

FIG. 14 Two block diagrams depicting the principles of the Exchanger. A primary depiction is the significant difference in hydrostatic pressure between Chamber A and Chamber B when Chamber A as InPort A is open. Under these conditions Chamber A is essentially equivalent to being the total body of water and being large in comparison to the small Chamber B and its smaller hydrostatic pressure. The first block diagram depicts that the Vessel Conduit between Chamber A and Chamber B as closed. The second diagram most specifically represents that the Vessel Conduit between Chamber A and Chamber B is open. The hydrostatic pressure on Chamber B is equivalent to the whole of the body of water and sufficient to move the Slider B of Chamber B upward against the smaller Chamber hydrostatic pressure with the Slider B now being positioned at the top of Chamber B. The OutPort from Chamber B is open to the body of water during the process to create higher velocity flow and higher pressures.

FIG. 15 Flow chart of the steps of operation of a Vessel having two Chambers separated by a Vessel Conduit that gives access to Slider Link movement as an additional source of energy exchange, as well as showing access to energy from water flow through OutPort at higher velocity and pressure.

FIG. 16 Flow Chart of the steps of operation of an Exchanger without a Vessel Conduit due to having a linear Vessel configuration and two Chambers divided by a Slider, and focusing energy extraction upon water flow, water velocity, and water pressure.

### DETAILED DESCRIPTION OF THE INVENTION

A description will now be made to an apparatus called an Exchanger and detailed reference to drawings of various configurations and preferred modes of transforming hydrostatic pressure to Flow, Motion, and their combination to facilitate the wellbeing of society. The present disclosures are described in sufficient detail that it will be apparent to those skilled in the relevant art to make and perform the disclosure. It will also be apparent to those skilled in the art that some aspects of the disclosure contained features that need no detailed description for the sake of clarity. Other items are listed to show the uses or adaptability of the Exchanger, but are not within the thrust of the invention, will not be described in detail for the sake of clarity around what is being claimed.

In addition, for the benefit of persons having ordinary skill in the art who elect to practice this disclosure, this description is organized into identifiable sections. These include a review of the principles relied upon by the Exchanger; then paragraphs grouped to describe common Elements and terminology with any needed features of the Exchanger; then detailed description of drawings, best modes, and adaptations of the Exchangers that fall within what is claimed; among potentially other helpful insight to eliminate undue experimentation.

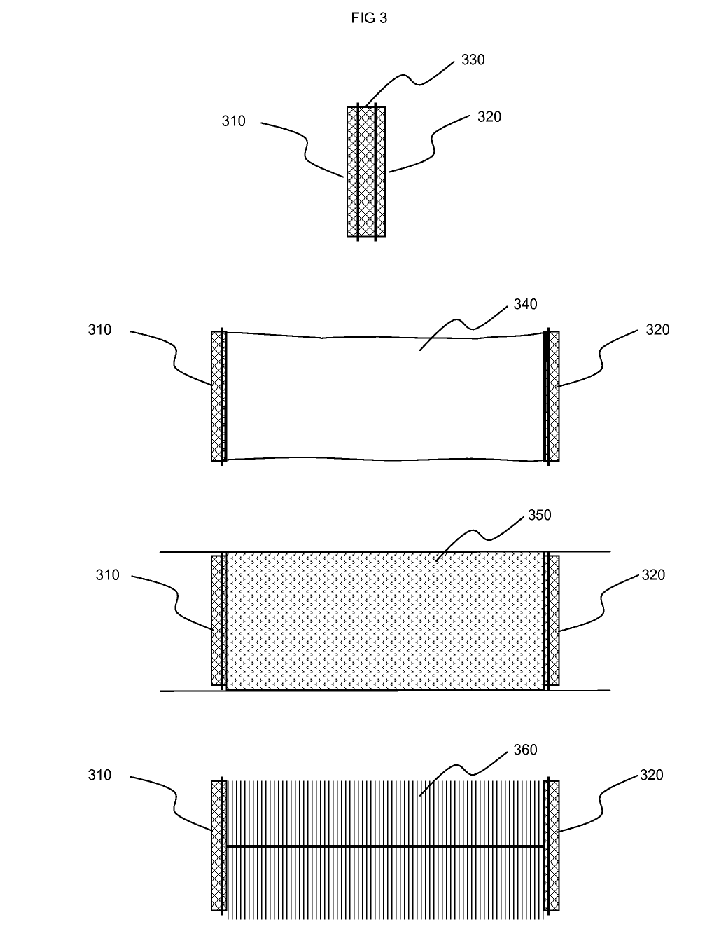

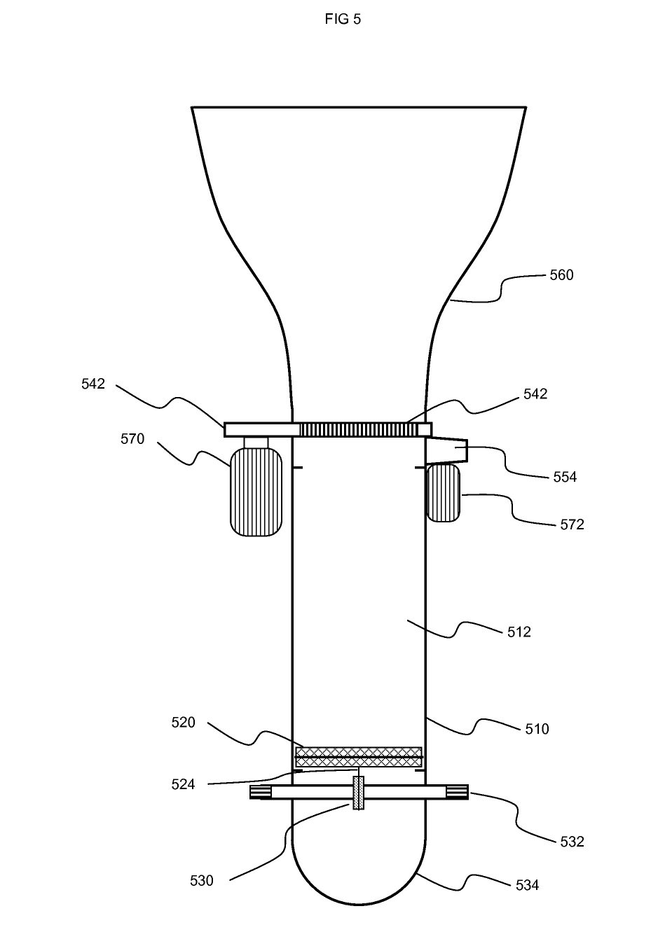

Note that components of the Exchanger are defined by two numbers; a drawing or figure number and an Exchanger Element or component number. For instance a commercially available compressor is given number 80 throughout the description and may be depicted with the Exchanger in drawings or FIGS. 3 and 5. Therefore the compressor will be listed in the definitional paragraphs as compressor F80, but in the specific drawings it will be referred to as 380 and 580.

### PRINCIPLES OF THE INVENTION

The Exchanger provides a simple, scalable, and dependable apparatus to exchange limitless, spontaneous, and constant hydrostatic pressure or energy available from a volume of water or other fluids into Available Energy. Hydrostatic pressure will be used as descriptive of all forces that create potential energy from a liquid at rest, such as stationary or quiescent water, and flowing or turbulent water collected locally in a volume.

The pressure created within that stationary water at a known depth is termed hydrostatic pressure, and is summarized as
Fluid Pressure P=ρgd
   Here where P is the pressure (N/m2, Pa, lbf/ft², psf, etc.), ρ is the density (kg/m³, slugs/ft², etc.) or mass consideration of the liquid, g is gravity (9.81 m/s², 32.17405 ft/s², etc.), and d is the depth into a body of liquid or substituted by h for height when using a column of liquid (m, in, etc.). The density of water is 1,000 kg/m³.

The core principle of the Exchanger is the conversion of stationary water to useful moving water due to a pressure differential within the volume of water. A two Chamber system is used to create this differential pressure and is effectively submerged in stationary water to access a hydrostatic pressure driving force based largely from gravity acting upon water and the significant mass of water.

Chamber 1 is positioned as open and exposed to the hydrostatic pressure P₁ of the stationary water at some depth d₁
Chamber 1 Hydrostatic Pressure P₁=ρgd₁.

Chamber 2 is positioned as closed or structurally capped to restrain or hold the external hydrostatic pressure away from the water in the Chamber. This converts and limits the Chambers hydrostatic pressure P₂ to the height h₂ of the Chamber
Chamber 2 Hydrostatic Pressure P₂=ρgh₂.

The difference in pressure between Chamber 1 and Chamber 2 can be the same or established to be significantly different based upon the distance, d, of the capped Chamber from the surface of the body of water or height of a water Chamber. Often there would be interest in maximizing the difference between the distance, d₁, of a physical or hypothetical column of water over the opening of Chamber 1 and the height, h₂, of Chamber 2 and defined by the dimensions of the Chambers.
Hydrostatic Pressure of Chamber 1, P₁>>>P₂, Hydrostatic Pressure of Chamber 2
ρgd₁>>>ρgh₂
d₁>>>h₂

The difference in pressure causes the sealed Slider near the hydrostatic pressure front of Chamber 1 to begin moving towards the lower pressure Chamber 2. Adding a small opening in Chamber 2 allows the large external submerged hydrostatic pressure acting through Chamber 1 onto the Slider to push the water in Chamber 2 through the OutPort of Chamber 2.

Under conditions where the surface area of Chamber 1, the Slider, and Chamber 2 are the same and the OutPort of Chamber 2 is ideally some percentage
A_{C1}=A_{C2}>>A_{O2}
   then consistent with physical principles expressed in the continuity equation of fluid flow rate, there is an increased velocity through the Chamber 2 OutPort.
V_{C1}A_{C1}=V_{O2}A_{O2}
V_{C1}A_{C1}/A_{O2}=V_{O2}
V_{C1}<<V_{O2}

Stationary water hydrostatic pressure has now been converted to flowing hydraulic pressure. Hydraulics pressure is the dynamic pressure or type of kinetic energy derived from the mechanical properties of liquids in motion. Hydraulic pressure opens up new energy opportunities
Kinetic Energy=½*Mass*Velocity²
Force=Mass*Acceleration=Pressure*Area
Fluid Flow Rate Q=Velocity/Time
Fluid Horsepower=PQ/g=(Pressure*Flow Rate)/Gravitational Force
and more useful conversions.

An Important consideration of the above system is returning the fluid in motion back to the stationary water. In the above summary, the hydrostatic pressure working within Chamber 1 is transferred through the Slider to Chamber 2. In other words, the effective hydrostatic pressure at the point of the Chamber 2 OutPort is equivalent to the external hydrostatic pressure. Two Important conditions exist to empty Chamber 2 through the smaller OutPort. Those are increased pressure to overcome external hydrostatic pressure and fluid momentum that is inherent with hydraulic pressure. This momentum permits the fluid exiting the OutPort to continue on for a distance and eventually entrain itself into the stationary body of water at five times the radius R of the OutPort where velocity V plays a neutral contribution
dQ/dx=2πRV=(2π×V)/5
5R=x

As the Slider ends its stroke and Chamber 2 is emptied, Chamber 1 has filled with water. A capping of Chamber 1 isolates the water within it from external hydrostatic pressure. Opening Chamber 2 to external hydrostatic pressure again creates a differential pressure between the Chambers as transferred by the Sliders. Upon opening the OutPort of Chamber 1, the Slider moves in the direction of the lower pressure Chamber 1. The higher pressure and higher velocity hydraulic water flow is again created by passing through the OutPort of Chamber 1. The cycle is repeated as a type of hydrostatic pressure reciprocal engine.

The cycle of intermittent to continuous hydraulic flows can be created by simultaneous and appropriate sequenced Chamber closures and openings for hydrostatic pressure inflows, restraints, and smaller area outflows. In addition the simplicity of the Exchanger permits it to work singly or in concert with a plurality of similar devices in any form of unison or offset cycle timing. Further the dimensions of the Chambers can vary based upon situational conditions of space, available hydrostatic pressure, materials, economics, need, among many other factors. The device is also adaptable for submerged, semi-submerged, and non-submerged applications.

The above background is provided to aid in understanding the harnessing of hydrostatic pressure generated from gravitational force upon water and the mass of water to be used by the Exchanger to create Flow, Motion, and their combination to produce a Available Energy. The background is illustrative only, without restriction of the physical structure of the device in implementing the conversion of hydrostatic pressure into Available Energy by creating a differential pressure. The generalized equations and principles used in the background are not claimed with the disclosure, but are for illustrative purposes only to succinctly express applied principles facilitating the utility of this disclosure. It is recognized that a full derivation of the equations and consideration of the system would include other considerations of restrictive flow, boundary layers, and more. The influence of these conditions is set aside in the above discussion with reasonable justification.

Disclosed is a simple, robust, and environmentally benign system deriving its benefit from an endless source of hydrostatic pressure spontaneously formed from a volume of water and known to be associated with the higher 40-60% conversion efficiency. Also disclosed is a scalable and reliable system capable of reaching replacement energy levels independent of climatologically and astrological conditions. The invention may be more fully understood by reference to the drawings that follow.

### COMMON ELEMENTS, TERMINOLOGY, AND DEFINITIONS

The following paragraphs are a grouping of common Elements of the Exchanger, common terminology, and useful definitions to facilitate an organized and clear understanding of the Exchanger.

The Exchanger is a single word referring to what is being claimed as the invention from its simplest preferred core description to its most embellished application demonstrating its utility and adaptability to societies worldwide. The Exchanger is the total apparatus which transforms hydrostatic pressure from a volume of fluid and its sum of forces and properties into Available Energy from Flow, Motion, and their combination for useful purposes.

Element is used throughout this disclosure to represent components of the Exchanger. Any identifiable piece of the Exchanger may be singly or collectively with other pieces referred to as an Element. The word Element in this disclosure is not referring to the atomic or molecular make up of pieces of the Exchanger. It is a word choice only as to reserve words like component for other uses.

Available Energy is used as a term to describe all forms of energy available from the Exchanger in their raw and intermediate from. One form of energy is derived from the properties of fluid flow or hydraulics and fluid dynamics that describe fluid flow, fluid pressure, fluid momentum, and other properties. A second source of energy is derived from Exchanger Element movement or mechanical motion and associated kinetic energy. Available Energy refers to the forces just described that are capable of driving other devices that may provide for a Available Energy. This includes Available Energy to drive a generator to transform fluid flow or mechanical motion into electricity. Other Converters transforming Available Energy in the form of fluid flow, fluid pressure, and mechanical motion as described into useful purposes are compressors, pumps, mechanical transmissions, and other devices.

Useful Energy is the energy for human interface and for purposeful use. It is electricity now available in distribution systems. It is compressed air that can be easily controlled and harnessed to drive other devices. It is water being pumped into fields. It is hydraulic oils being pumped and controlled to drive machines. It is mechanical movement controlled through transmissions that provide for useful work. It is [I removed the word not, it seemed to be incorrect] an Available Energy of raw force that is obtained from Flow and Motion that must be converted to a Useful Energy.

Fluids refers to any available fluid as the simplicity of the Exchanger and its basis upon scalable physical properties makes it functional as a small toy to a mega utility power source bringing benefit to communities and activities as needed. The fluid of use most likely represents water with its access and abundance across the world. Not intended as an exhaustive list, yet by way of example among other fluids persons having ordinary skill in the art would identify fluids to include petroleum and nonpetroleum based liquids and oils, aqueous and nonaquesous solutions, alcohols, gases, other materials that flow, and their combination. The use of alternative fluids may be for specialized purposes, reduce bacterial growth, high pressure behavior, unique thermal conditions, viscosity choices, or other choices to create more ideal use conditions. The Exchanger is capable of operating as a closed system that recalculates the fluid so as to effectively operation with a defined amount of fluid. Without restriction to the inclusion and use of other fluids, water will be used in the remaining description and represents the word fluid.

Flow refers to the motion of a fluid. It will be referred to as flow, but may also for emphasis of the power and potential of the flow be referred to as hydraulic pressure or pressure. Hydraulic pressure is descriptive of fluid dynamics or fluid in motion. Fluid dynamics, hydraulic pressure, and other fluid principles are adopted as already well documented, derived, and understood.

Flow and Motion refers to the movement of both mechanical components and fluid dynamics that are the result of the Exchanger. The utility of the Exchanger is to take an ever present, abundant, universal, and locally infinite potential for energy in the form of hydrostatic pressure and convert it to a mechanical motion or a fluid motion or flow. It is this flow and motion that is harvestable for useful purposes. For purposes of example only, and not as a limiting list, motion created by the Exchanger may include flowing to stationary fluids, linear or vector movement, rotary movement, shearing, other, and their combination. Flow and motion are considered the same, and are often described as Exchanger Element mechanical movement and kinetic energy as well as fluid dynamics, hydraulics, and water flow and water pressure. Again flow and motion represent those results of the exchanger that can be utilized to extract an Available Energy.

An Energy Site is a location on the Exchanger where Available Energy is made available for use. That is a place that an electric generator, compressor, pump, mechanical transmission, or other device can connect to the Exchanger and utilize the energy OutPort.

Hydrostatic pressure has previously been discussed, but is addressed again for purposes of clarity. Hydrostatic pressure is a two word phrase representing the combination of all forces developed from a volume of fluid, be it stationary, turbulent flow, a semi-stationary wave flow, or pooling of flowing water. Not limited by, but by way of example of all available forces, hydrostatic pressure is a product of gravitational forces acting upon water which has its physical properties to include the mass of water. Hydrostatic pressure is well studied and known to have, among other properties, to act universally in all directions with equivalent magnitude. Hydrostatic pressure used throughout this description includes all the properties of a volume of fluid known within the science for each respective fluid, in this case water will be the descriptive fluid.

Higher and lower hydrostatic pressure are used to described the driving force of the Exchanger. The exact value or magnitude of the hydrostatic pressure is not known and can easily change with several conditions. Such conditions include how deep the Exchanger is submerged, either in a body of water or under a container. It is also defined as to how larger the Chambers are within the Exchanger. As previously stated, note that the potential energy of a cubic meter volume of water is the constant exertion of 62.42796 pounds of pressure per cubic foot or a cubic meter weighing about 1 ton. A column of water 1 ft.² at a depth of 100 feet exerts a pressure at its base of 6242 pounds of pressure (three tons). The same column of water at 500 feet would exert nearly 16 tons of pressure at its base. When referring to higher hydrostatic pressure, it is suggesting the Exchanger or the Chamber is under the larger external hydrostatic pressure of the body of water or the container. The lower hydrostatic pressure is referring to that value created by the dimensions of the closed chamber or chamber dimensions. Through chamber cycles, the higher hydrostatic pressure overcomes the lower hydrostatic pressure to create flow and motion. Higher and lower are not arbitrary with referring to the relationship of difference of hydrostatic pressure acting on the Exchanger and Chambers.

Submerged, semi-submerged, and non-submerged terms are used as general descriptions of the application environments of the Exchanger. Submerged represents that the totality of the Exchanger and all of its Elements are under the surface of the water. Undoubtedly there will be cords, cables, conduits, and other Elements connecting the submerged Exchanger to users and support infrastructure. The submerged environments include oceans, seas, bays, lakes, pools in flowing water, and other natural sources; as well as human made structures of dams, reservoirs, slides and cascades, tanks, and other structures that generally or specifically accommodate the Exchanger. In most of these applications, the volume of water is large enough to have an effect upon the Exchanger as if the water was infinite in volume, but this is not a necessary feature. It is acknowledged that the depth of the effective body of water or container will have an effect upon the magnitude of force acting upon the Exchange. Exchanger location, specific size, design features, use needs, and other considerations, and their combination are encompassed by what is claimed. Semi-submerged is a term representing that any portion of the Exchanger could be partially in and partially out of the water. These application environments include all those listed for use with the submerged Exchanger and less voluminous but effective amounts of water in containers. This may be simply for design and convenience purposes or for functional requirements for the specific application. Non-Submerged represents applications where the core of the Exchanger, except for such items as components for access to water sources, are outside the water. The applications sites for the non-submerged Exchanger include being adjacent to, above, or below with encasement any of the environments listed with submerged and semi-submerged applications.

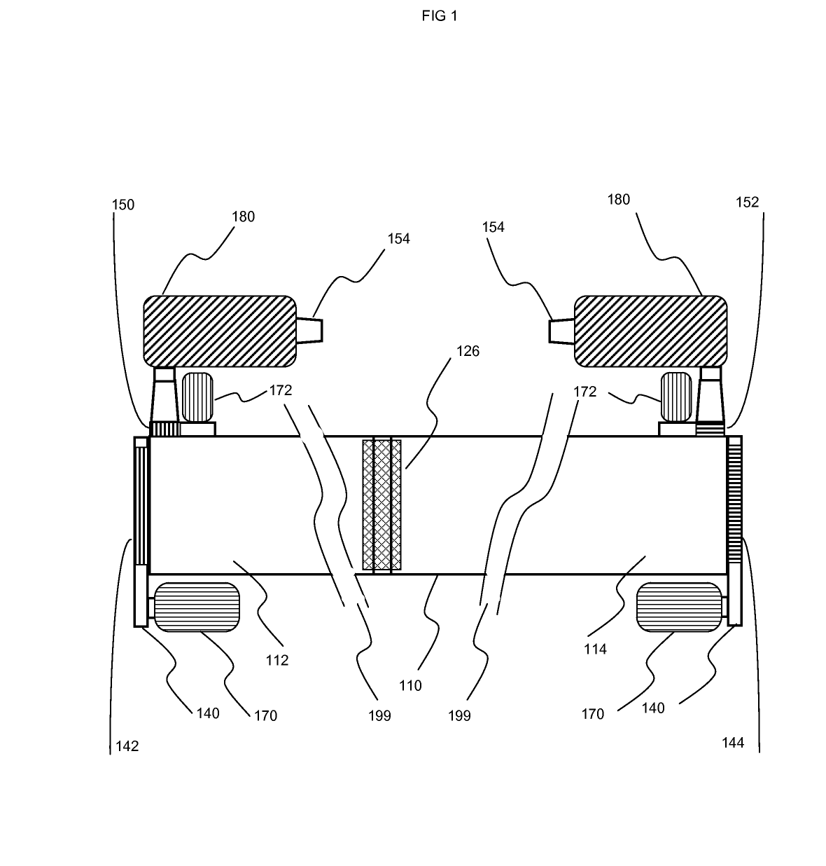

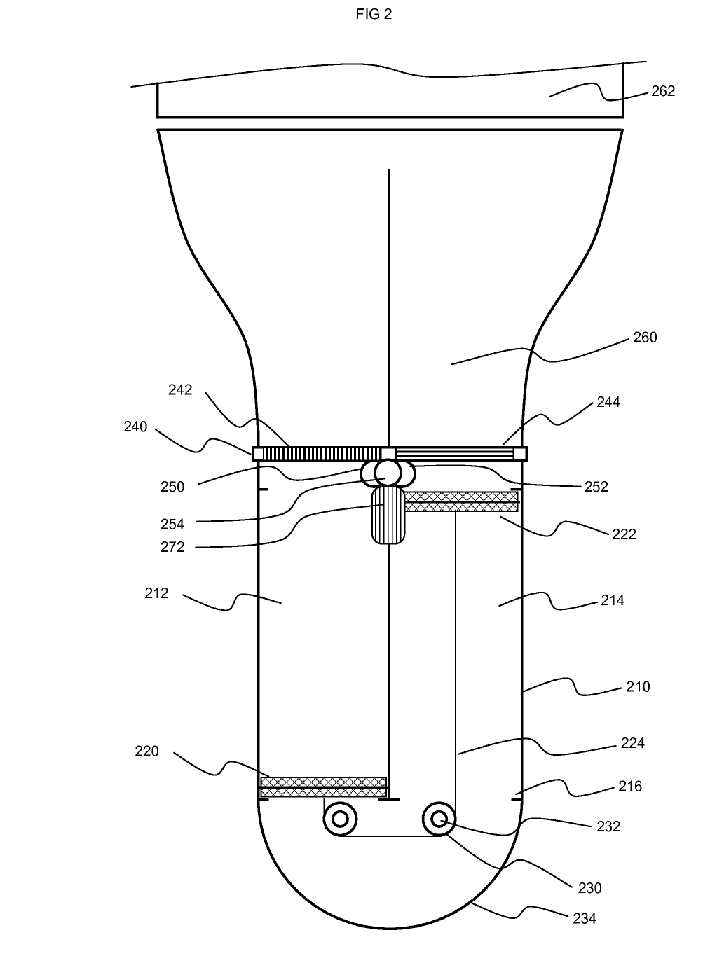

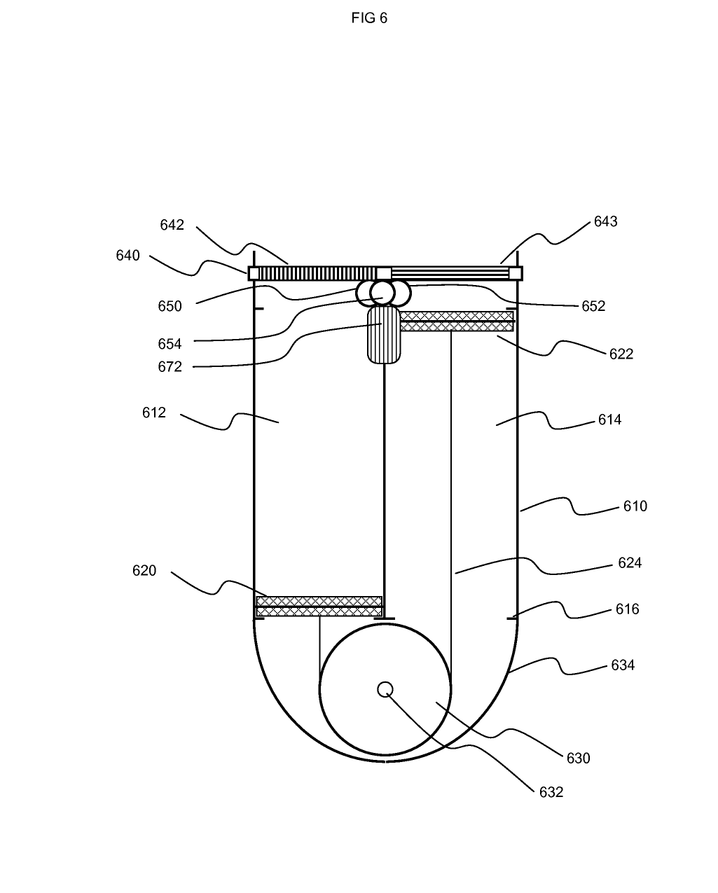

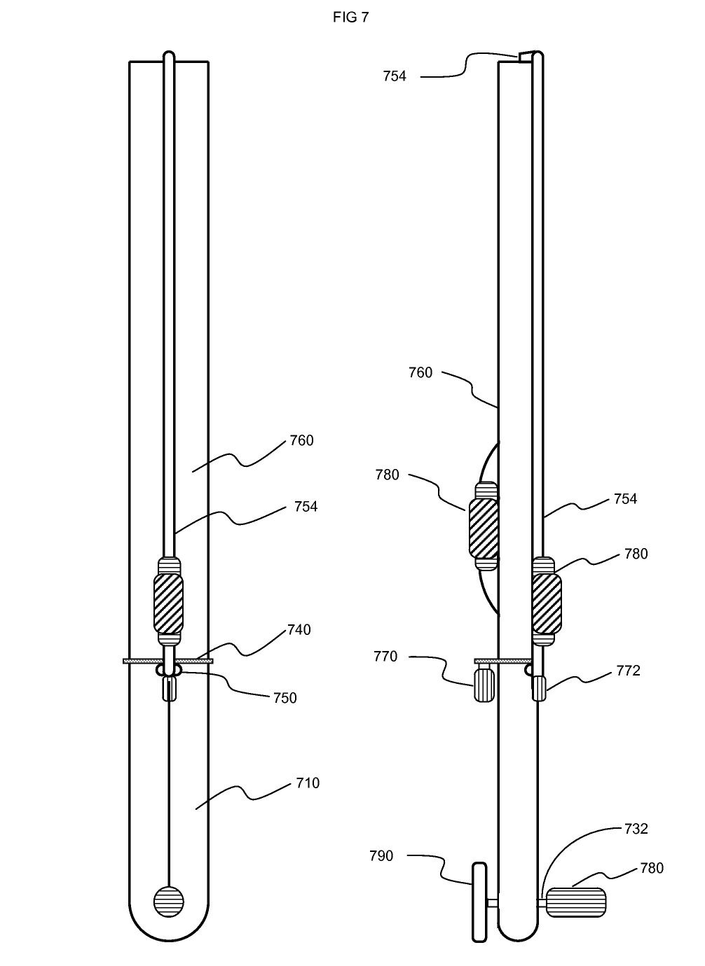

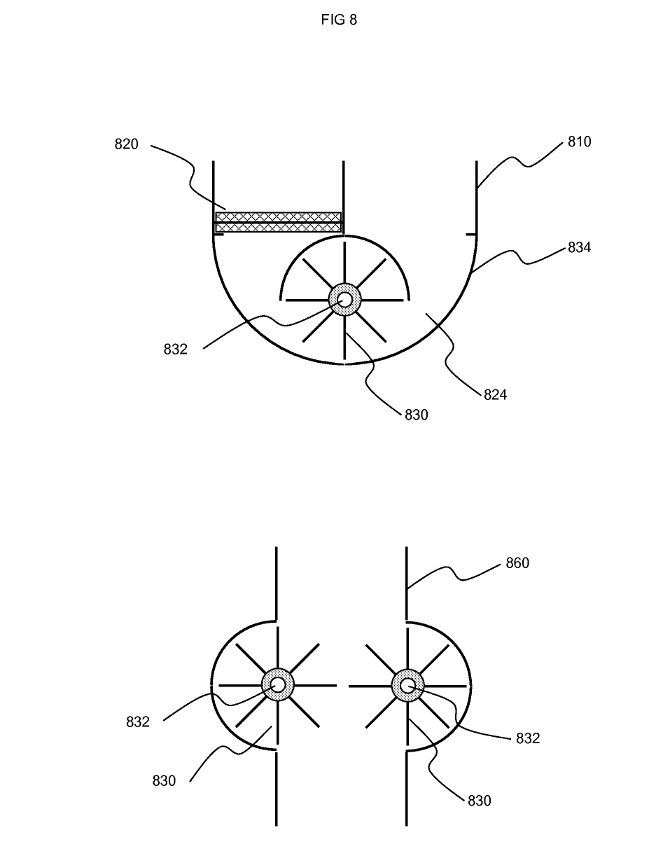

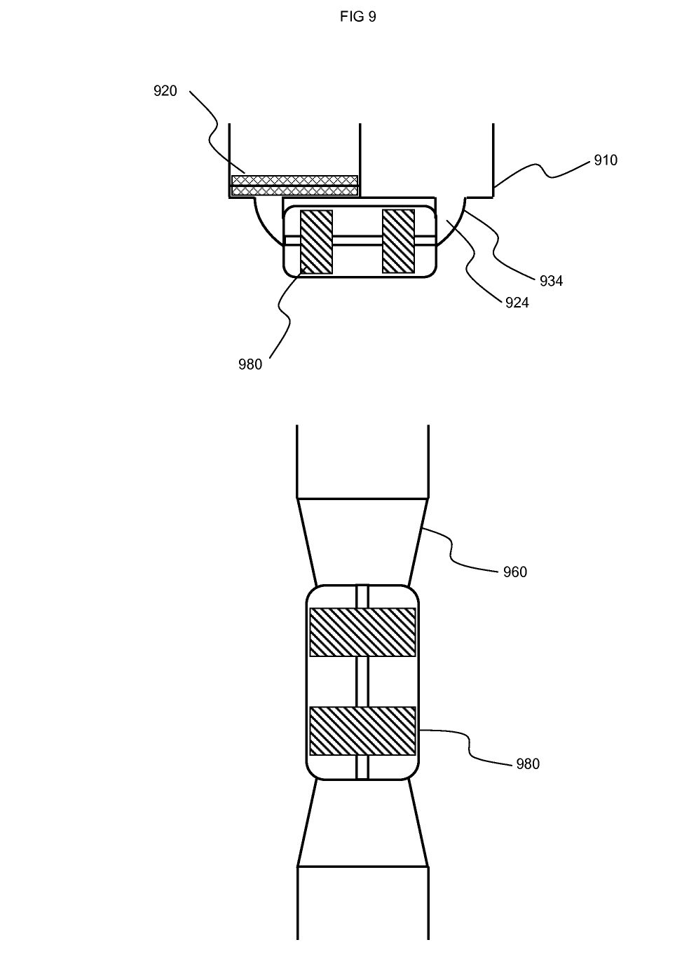

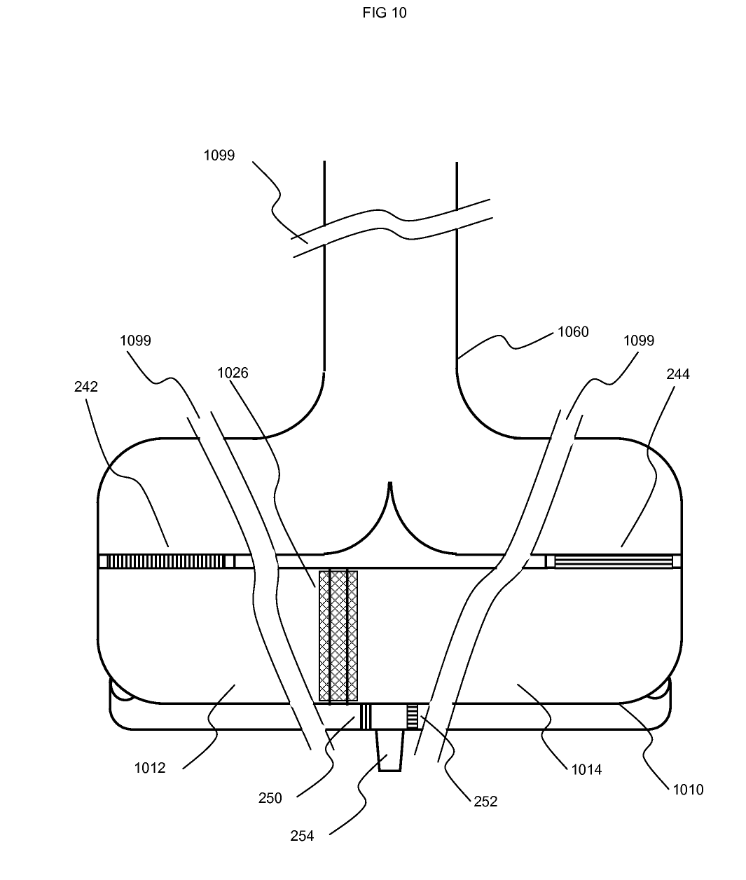

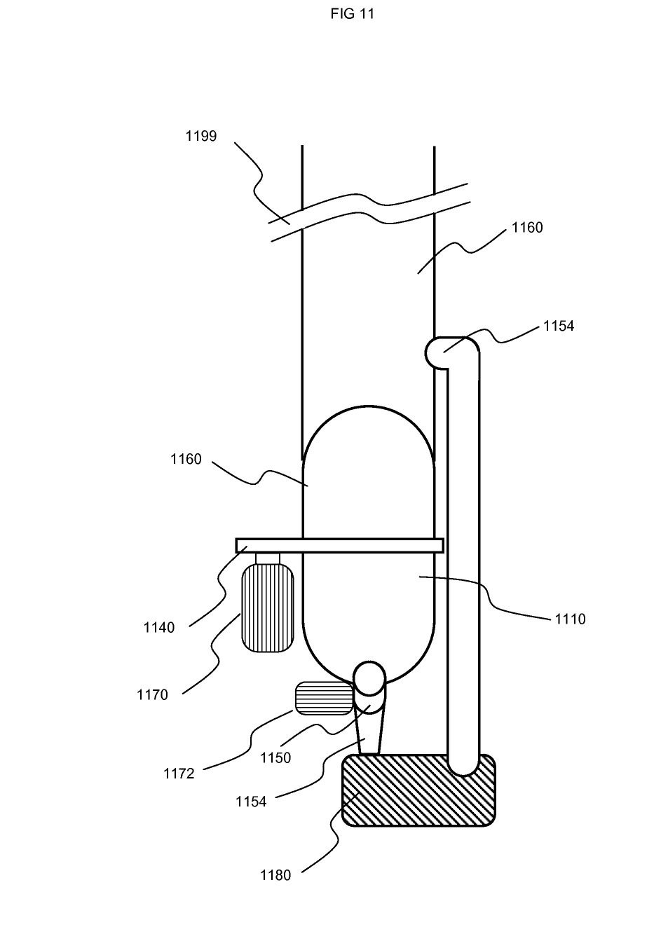

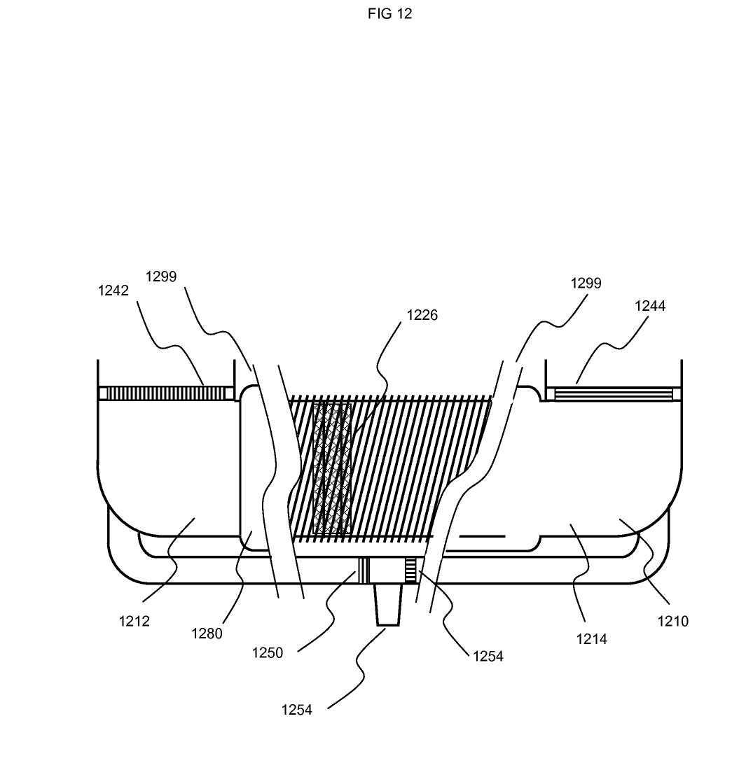

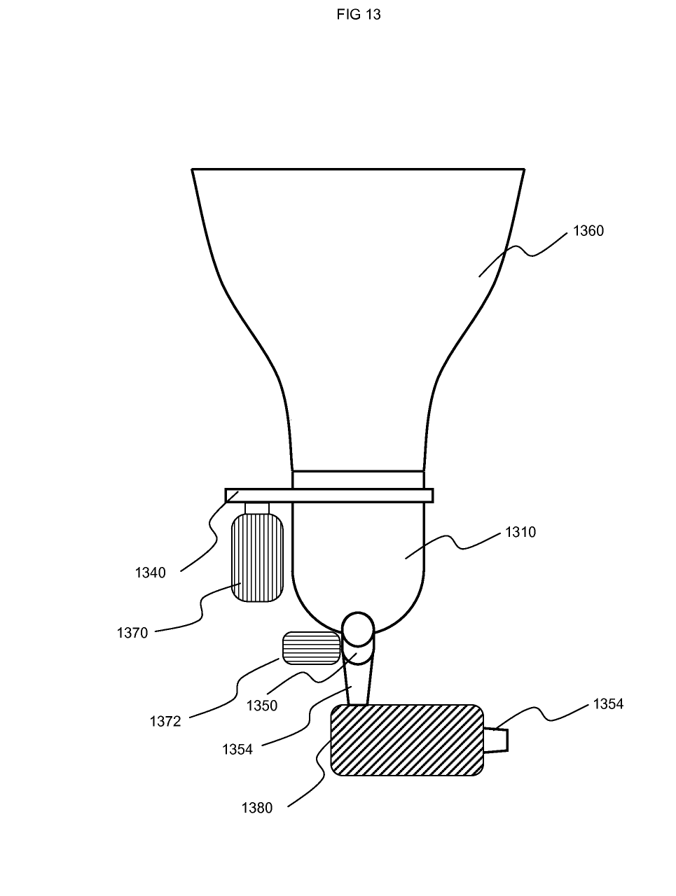

Generalized nomenclature for the figures has been adopted such that the description of common elements remains relevant to each figure to which that element pertains. Throughout this description there is nomenclature such as “two Chambers F12 and F14.” This nomencleature is divided into two sections, the figure (FIG) indicator “F” and the numeric figure element, in this example being 12 and 14. F12 and F14 refers to every figure “F” where there is an element 12 and 14. Such as FIG. 2 with Chamber 212 and 214; and FIG. 6 with Chamber 612 and 614 depicted; and FIG. 12 with Chambers 1212 and 1214. When speaking of the properties of the Chamber, those same properties apply to specific Chamber references made in FIG. 2, FIG. 6, and FIG. 12. As another example that immediately follows, there is Vessel F10. This represents the common characteristics of the Vessel apply to all cases in which the Vessel is referred. With regard to the Vessel that means properties applied to FIG. 1, FIG. 2, FIG. 5, FIG. 6, FIG. 7, FIG. 8, FIG. 9, FIG. 10, FIG. 11, FIG. 12, and FIG. 13, and commonly represented as F10.

The Vessel F10 is some form of continuous Vessel Conduit and may be any configuration with length, width, height, geometry, other spatial character, and their combination that holds a volume of fluid and manages pressure, motion, flow, or their combination. By way of example, yet not intended to be a comprehensive and exclusionary, the Vessel is illustrated as a tube or cylinder and at times is a straight linear device and in other platforms is curved back as adjacent tubes with both primary opening oriented in the same direction and next to each other and their combinations. Vessels are constructed to have less than 10% shaped deformation in any dimension. Not intended to be a limiting list, but by way of example the Vessel may be comprised of metals, ceramics, carbons, minerals, cements and concretes, glasses, polymers, composites, elastomers, and their combinations under given conditions of hydrostatic pressure or preference. Current Chamber preference is a combination of concretes, metal, and polymeric materials.

Two Chambers F12 and F14 (such as in FIG. (F) 2 with 212 and 214, and FIG. (F) 6 with 612 and 614, and other figures showing Chambers) are formed and present in the Vessel. Chamber volumes are likely to be equivalent, but may also be nonequivalent. The Chamber is also characterized by having a controlled and managed pressure. The Chambers are created by a mechanism that divides the Vessel into two Chambers with each capable of controlling its hydrostatic pressure conditions. By way of example only, and not intending to be limiting, that mechanism dividing the Vessel into Chambers is depicted by a Slider, but may also be created by bi-directional valves and gates, mono-directional valves and gates, mechanism timing, motion or flow and associated momentum, diaphragms, restrictive flow, pumps, other mechanical devices, or their combination. The internal length of the Chamber can be altered by stops F16 or other artificial mechanisms or Vessel component limitations, but this small list is made only as an example and not intended as a comprehensive list. Chambers are constructed to have less than 10% shaped deformation in any dimension. Not intended to be a limiting list, but by way of example the Chambers may be comprised of metals, ceramics, carbons, minerals, cements and concretes, glasses, polymers, composites, elastomers, and their combinations under given conditions of hydrostatic pressure to preference. Current Chamber preference is a combination of concretes, metal, and polymeric materials.

The Slider is composed of two Slider Surfaces F20 and F22, and a Slider Link F24 that keeps the Slider Surfaces in spatial relationship and acting as one Slider Element.

Each Slider Surface is associated with a different Chamber. The name Slider Surface is not intended to be interpreted as just a surface, but an Element of the Exchanger with width, height, depth, and other geometric features to match the Chamber shape and use conditions it is serving. Slider Surface F20 moves throughout Chamber F12 and Slider Surface F22 moves throughout Chamber F14. All Slider Surfaces as depicted by Slider Surfaces 310 and 320 are constructed to fit the Chamber and be substantially sealed against the Chamber wall. A substantial seal maintains less than 10% hydrostatic pressure change and may be created by fit and finish of the Slider Surface or by incorporating secondary materials. Not intended to be a limiting list, but by way of example the Slider Surface Seal and may be comprised of metals, ceramics, carbons, minerals, cements and concretes, glasses, polymers, composites, elastomers, and their combinations under given conditions of hydrostatic pressure to preference. Slider Surfaces may also contain primary or secondary properties, and by way of example without intending to be limiting incluse being partially or fully inert chemically, inert or insulating electrically, electrically conductive, magnetic, nonmagnetic, contact surface material with or without lubricity, wear surface material, touchness (nonbrittle), vary in properties on across the Slider Surface, other homogeneous or heterogenous or inserted, added, coated properties and their combination. Slider Surfaces are constructed to have less than 10% shaped deformation in any dimension. Not intended to be a limiting list, but by way of example the Slider Surface and may be comprised of metals, ceramics, carbons, minerals, cements and concretes, glasses, polymers, composites, elastomers, and their combinations under given conditions of hydrostatic pressure to preference. The current preferred Slider Surface and Seal material to be metallic and polymeric. The adaptability of the Exchanger may cause Chamber designs to adapt to use conditions, which will in turn cause the dimensions and materials of the Slider and its Slider Surfaces to vary.

The Slider Link joins the Slider Surfaces together into an Element acting as a single Slider. It can be configured from a small tether to a form filling the Vessel space in which it resides. Its construction may be a nature of heterogeneous, homogeneous, interconnected components, and their combination. The Slider Link will be incompressible or show less than 10% compression or elongation under conditions of the hydrostatic pressure and other use conditions. Only by way of example, not intended to be limiting, Slider Link materials include metals, ceramics, carbons, minerals, cements and concretes, glasses, polymers, composites, gels, elastomers, and their combination. Also include are cellulosic, polymeric, metallic, and other materials as single fibers, multiple fiber strands, and multiple strand cables, ropes, or connectors. The preferred Slider Link is Exchanger, Extractor, or Converter design dependent. Slider Link construction can take many forms by utilizing different materials to accommodate different Exchanger designs, use condition adaptation, preferences, performances, other reasons, and their combination. Not intended as a limiting list but discussed are a few examples of Slider Surface and Slider Link configurations and adaptations, the following is provided. Slider Link 224, 524, and 624 shows a cord of single to multi strand construction with properties of forward and aft utility. Slider Link 330 is shown to be part of a homogenous structure with Slider Surfaces 310 and 311. This will often be a preferred form as a smaller type of compact and simple unit. Surface Link 340 is a solid yet flexible material. Slider Link 350 shows a connection by way of a liquid, semi solid, gel, composition, compressed gas, or their combination. Slider Link 360 shows a mechanical link comprising a flexible core with alignment and registry derived from non-compression discs or plates. The combination of the above are also available, such as the tether type Slider Link of 224 being combined with a water fluid link shown by Slider Link 350. The Slider then is a description of two Slider Surfaces held in substantially constant registry by a Slider Link and with the Slider purpose of transferring hydrostatic pressure on one Chamber to another.

InPorts are associated with each Chamber at the Chamber end that accepts hydrostatic pressure sources. The purpose of the InPort is to contribute creating a difference in hydrostatic pressure between the two Chambers. Chamber F12 includes InPort F40 and Chamber F14 includes InPort F42. The InPort is a device with two functions. One function is to hold away or restrain external hydrostatic pressure from acting upon internal Vessel Chamber. The second function is to open the Chamber to the external hydrostatic pressure and water flow. In familiar language the InPort acts like a cover and a valve. Not an exhaustive list but only by way of example, the InPort may have a construction like a ball valve, gate valve, iris structure, butterfly, seat closures, plug, diaphragm, disc, flap, piston, other valves, other mechanisms, and their combinations. Without intent to limit, but by way of example, InPort materials include metals, ceramics, carbons, minerals, cements and concretes, glasses, polymers, composites, elastomers, and their combinations. Regardless of the material or design the InPort will fulfill its first purpose as a restraint to external hydrostatic pressure by being substantially sealed or to allow less than a 10% change in internal Chamber hydrostatic pressure over the course of a Slider cycle. The InPort will fulfill its additional purpose of opening to expose the Chamber to external hydrostatic pressure at a rate that provides for a full useful Slider cycle in overcoming any Slider and Exchanger Element resistance. Without intent of limitation, but by way of example of many acceptable InPort designs and construction, the following two examples are illustrated. In each example each InPort shown displays an InPort Framework 440 for connecting InPorts to an Actuator and to the Vessel, with other configurations acceptable. The first is a segmented butterfly control plate valve InPort. The InPort open position 442 illustrates InPort control plates oriented parallel with the flow of water and permitting hydrostatic pressure to act upon the Chamber. InPort closed position 444 illustrates control plates oriented perpendicular with the flow of water and substantially sealed to withhold the external hydrostatic pressure from being exerted on the Chamber. InPort open position 442 and InPort closed position 444 illustrates that for a two Chamber Vessel construction, one Chamber will be open and the other Chamber will be closed to water flow and hydrostatic pressure affects. The InPort will cycle between the two Chambers by being open or close, and of course some transitional and partial opening and closing will occur. A preferred second InPort device shows operations by horizontal motion. Here Inport Closure 450 is positioned and aligned with InPort Framework 440 leaving Inport Opening 452 for water flow and the force of external hydrostatic pressure upon the Chamber. On the opposite side of the InPort is Inport Closure 460 in position over the Chamber openings and exposing the InPort Framework 440. The operation of the InPort is such that one InPort is open and the opposing cylinder InPort is closed 462. Variations in the opening and closing and their timing of the InPorts may vary to optimize performance of the Exchanger. The closed InPort and closed OutPort create a low hydrostatic pressure environment on which the opposing Chamber of open InPort and optionally opened OutPort allow higher external hydrostatic pressure to act through the Slider creating a higher force acting upon the filled and closed lower hydrostatic pressure Chamber which then the water contents of the Chamber are exhausted out an open OutPort.

OutPort F50 and OutPort F52 exhaust water from the two separate Chambers. Not necessary, but by way of preference or application considerations the two OutPorts may be joined into a single OutPort Return F54. The OutPorts are located in proximity or adjacent to the InPorts. The function of the OutPorts is similar to the InPorts. One function is to hold away or restrain external hydrostatic pressure from acting on the internal Chamber hydrostatic pressure by closure. An additional function of the OutPorts is to exhaust water from the lower pressure Chamber as the higher hydrostatic pressure acting upon the opposite Chamber is exerted through the Slider. The OutPort may also contribute to introducing external hydrostatic pressure into the Chamber by being open simultaneously with the open InPort of the same Chamber. Operationally the OutPort will be electively closed during the power push of the Slider under higher hydrostatic pressure. The OutPort may also be open during this phase to add additional entry of external hydrostatic pressure. If the OutPorts are joined into a common OutPort Return F54, a specific configuration of the OutPorts may not allow for the OutPorts to remain open without interferring flows. Depending upon the rate of cyclical action by the Slider the OutPort may need to be closed prior to the full range of Slider movement to create and maintain a lower hydrostatic pressure in the Chamber just experiencing the power push. If the InPort of the Chamber just experiencing the exhausting of water from its contents is opened before the Slider reaches its maximum travel near the InPort than the Slider will begin to move in the opposite direction and begin acting upon the opposite Chamber through the Slider to push out the water that just filled the opposite Chamber. This level of timing and synchronization may be preferred as a system change before a steady state of hydrostatic pressure can be established and therefore electively allowing the OutPort to not be closed at all during operational cycles. Key to any cycle is that as one InPort is open the InPort of the opposing Chamber must be closed simultaneously. If the OutPort is elected to be closed during the Slider cycle, then the OutPort will be closed in the Chamber filled with water until the Slider begins to push on the water in the same Chamber and an exhaust port opening is needed, at which time the OutPort of that filled Chamber will be opened. Variations in the opening and closing and their timing of the OutPorts may vary to optimize performance of the Exchanger. In familiar language the OutPort acts like a cover and a valve and may have structure like that of the InPort. Not an exhaustive list but only by way of example, the OutPort may have a construction like a ball valve, gate valve, iris structure, butterfly, seat closures, plug, diaphragm, disc, flap, piston, other valves, other mechanisms, and their combinations. Without intent to limit, but by way of example, InPort materials include metals, ceramics, carbons, minerals, cements and concretes, glasses, polymers, composites, elastomers, and their combinations. Regardless of the material or design the InPort will fulfill its first purpose as a restraint to external hydrostatic pressure by being substantially sealed or to allow less than a 10% change in internal Chamber hydrostatic pressure over the course of a Slider cycle. A consideration of the principles of Exchanger operation the OutPort is at least slightly smaller or 80% of the size of the InPort or smaller. Smaller size of the OutPort can be a determining factor on its specific construction. The smaller sized OutPorts is integral to accelerating velocity of water flowing through the Chambers and then exhausting through the OutPorts. As previously stated, one way to explain this acceleration is by continuity of water flow. That is an equal amount of all water flowing within the system, and acceleration OutPort is small to compensate for the smaller OutPort size.

A MidPort is introduced in a block diagram to emphasize a point, but is an Element capable of inclusion in the Exchanger. The MidPort is located anywhere between the Chambers, and before, within, or after the Vessel Conduit. A MidPort has the same characteristics, purpose, and function as an InPort by regulating the influence of higher hydrostatic pressure on the opposing lower hydrostatic pressure Chamber. An InPort working in conjunction with a MidPort can seal a Chamber to maintain Chamber hydrostatic pressure. In summary, a function of the MidPort is to restrain the hydrostatic pressure from acting on the Chamber, and a second function is to provide an opening or closing to allow the external hydrostatic pressure to act on the Chamber in whole or part. There may be one or more MidPorts within the Exchanger. A MidPort would have the same material characteristics and possibilities as an InPort. A MidPort could have the same design and operational characteristics and possibilities as an In Port. The geometry of the MidPort of course will take the needed geometry of the Vessel Conduit or the interface between the Vessel Conduit and the Chamber.

Actuators are any device that creates the needed motion and movement of the chosen In Port, or OutPort opening and closure mechanism or other functionality of the Exchanger. The InPort Actuator F70 and OutPort Actuator F72, by way of example, and not a comprehensive list may include: a rotary electrical motor, a rotary hydraulic pump, a hydraulic ram, electro-attenuated polymers, electro-attenuated ceramics, mechanical components such as springs, levers, and catches; and other devices that facilitate the necessary function. The driving energy of the Actuator may be any form of energy to create the needed motion to facilitate action at the InPort and OutPort. Not a comprehensive list, but by way of example, may include: electricity generated from the Exchanger or from external electric sources, hydraulic sources, solar energy, thermal energy, hydrostatic pressure, hydraulic pressure, other energy sources, and their combinations. Exchanger Element momentum from water motion and momentum, water flow and momentum, energy or motion from an attached Converter, or again other sources of energy and their combination. Although not necessary but desirable the Actuators are sought to be efficient and preferably energy neutral, ideally but not necessary to operated from energy generated from the Exchanger, and not consume more than consuming 95% of energy produced by the Exchanger. This disclosure states the requirement for an Actuator, but does not design or claim a specific Actuator as part of the Exchanger disclosure, but expects to utilize Actuators available in the market.

A Container F60 above the Vessel InPorts and Container extension F62 is available in any height, width, depth or other geometric dimension and shape that will contain water. Only by way of example, not intended to be limiting, Container materials include metals, ceramics, carbons, minerals, cements and concretes, glasses, polymers, composites, gels, elastomers, and their combination, The Container is an option, but preferred Element to the Exchanger when deployed in a submerged application. The Container is an integral Element of the Exchanger for semi-submerged and non-submerged applications. The Container is integral to the Exchanger in applications of a closed system of recalculating water, stationary or quiescent water, turbulent or moving water, as well as flowing water where the Container creates a local stabilized volume with spontaneously generated hydrostatic pressure. Without the intent to be limited, but by way of example, the Exchanger can be deployed in and about oceans, seas, bays, natural lakes, rivers, streams, as well as man-made lakes and reservoirs, applications with flowing water, and other possible geographic applications and their combination with the presence of a Container. Regulation of hydrostatic pressure can be achieved by the dimensions of the Container particularly the height of the Container above the InPorts. The minimum height of the Container being 1.2 times the height of the Chamber. The maximum height, width, depth, and other geometric dimensions are without limit and in cases may be effectively infinite where the Exchanger is submerged in water. The magnitude of hydrostatic pressure can also be regulated by the geometry of the Vessel and Vessel depth with or without the Container in a body of water. Regulation of hydrostatic pressure can also be accomplished with the InPorts and OutPorts were designed to do such. Another available feature of the Container is the change in dimension the water passage just above the InPort. The diameter of the Container may range from the diameter of the InPort to any larger or smaller size in comparison InPort opening. Again by the principal constraint of volume flow a larger volume of water at the top of the Container under hydrostatic pressure will also accelerate as the Container narrows to the InPort. The combination of hydrostatic pressure at the point of the InPort plus increased InPort water flow velocity adds additional energy into the Exchanger.

The Vessel Conduit is a third segment of the Vessel. In addition to a first and second Chambers, Vessel Conduit F34 provides a path for the Slider Link to connect with the two Slider Surfaces of the two Chambers. The structure of the Vessel Conduit will vary largely dependent upon the type of Slider Link that is being used by the Exchanger. Another contributing factor to the character of the Vessel Conduit is the choice of Extractors used with the Exchanger. The material used for the Vessel Conduit is the same as that used for the Vessel and the Chambers.

The Extractor is an Element of the Exchanger that harvests Flow, Motion, and their combination to produce an Available Energy harnessed for conversion into useful purposes. The number of Energy Sites on the Exchanger may vary based on application conditions, needs, preferences, and the burden the Extractor and Converters place on the Exchanger. As the number of Energy Sites on the Exchanger may vary so may the number of Extractors applied to the Exchanger may vary. Only by way of example, not intended to be limiting, Exchanger materials include metals, ceramics, carbons, minerals, cements and concretes, glasses, polymers, composites, gels, and elastomers, and their combination as may be needed by the variety of sizes and application of the Exchanger. Not intended to be a limiting list, but by way of example, various Extractors are shown and can often become specific to the type of Slider Link employed. As a first example, the Pulley 230 and Axle 232 and companion Pulley and Axle set located in the Vessel Conduit 234 and provide for a dual purpose. The Pulley and Axle set provide for registry and alignment of the Slider Link 224 as well as provide one or two Energy Sites. The Pulley and Axle set is further clarified with the Pulley 530 and Axle 532 showing Pulley and Axle spatial character located in Vessel Conduit 534 with Energy Sites on both sides of the Vessel 210 and 510. By application requirement or by preference one or two Axle Energy Sites may be made available. A second example of a single Pulley and Axle Extractor is shown with Pulley 630 and Axle 632 in Vessel Conduit 634. The large diameter Pulley singularly provides Slider Surface registry and an Energy Site. Axle 632 by application requirement, preference, or other considerations may provide an Energy Site on one or both sides of Vessels 610. A further example of an Extractor is shown with Vessel 810 and Slider Surface 820 both previously depicted and specifically representing a Paddle Wheel 830 type Extractor on Axle 832 in Vessel Conduit 834. A highlight of this Extractor is that Slider Surface 820 and its companion Slider Surface (that is not shown) having a Slider Link 824 composed of an incompressible liquid, fluid, gel, or other composition as previously mentioned which keeps Slider Surfaces in proper registry and creates a fluid motion with each Slider cycle and creates flow and motion to move the Paddle Wheel 830. As in other figures Axle 832 can be extended by application demands or preference on one side or both sides of the Exchanger. Another example again with Vessel 910 and for reference purposes Slider Surface 920 shows a Turbine 980 Extractor. Extractor 930 (not labelled) is also labeled as Converter 980 as this device being in line with Vessel Conduit 934 and both extracts and converts Slide Link 924 fluid motion and flow to a useful purpose.

The Converter is an Element of the Exchanger and is used to transform Flow, Motion, and their combinations into a useful purpose. Without intent to be limiting by type, application, or means of converting Flow, Motion, or their combinations to a useful purpose, but by way of example, Converters include electrical generators, compressors, pumps, mechanical transmissions, and other devices using Flow, Motion, and their combinations to create a useful result by being acted upon directly by the Exchange, through an Extractor, or their combinations, with the objective of producing excess results to be used externally. As will be shown in examples that follow, the Converter may be an integral part of the Exchanger or as with the Actuator may be an Element taken from the marketplace and attached to the Exchanger at Energy Sites. The first example of this Element is Converter 780. Three Convertors of 780 are shown. Converters listed may be acquired off the market and may be used to produce the same or different results from the Exchanger. Assume in the following discussion the converter provides electrical power generation. A first Converter 780 is located and attached to the Container 760 powered by water flowing from the Container into the Chambers. The second Converter 780 is located on the combined OutPorts Return 754 and powered by exhaust water from the Chambers. The third Converter 780 is connected to Axle 732 and is not a turbine but more of a traditional generator of electric power. Other examples of the connection of turbines within and about the Exchanger could be identified, where as the specific examples are not intended to be limiting. The Vessel 910 with Slider 920 provide context to show Turbine 980 connected to Vessel Conduit 934 under the Chambers. In this example the turbine is powered by the Slider Link 924 of incompressible water, fluids, or gases. The number and location of Extractors and generators in, on, and about the Exchanger can be numerous and in a type of series or parallel relationship. Consider turbine 980 in relationship to Container 960 both above an InPort, not depicted below. There is also Converter 1180 connected to OutPort 1152 and operating horizontally and then exhausting to OutPort Return 1154. An electricity generating Converter 1280 is shown as a housing or cover over a set of winding through which a magnetized Slider 1226 within the chambers produces electricity with movement. As with all converters the specifics of electrical generation or other useful purpose generation is not specified, but in this case as the Slider 1226 with magnetic properties moves one way and then the other, the polarity of the energy will vary, requiring circuitry to produce a useful outcome. Among other components this circuitry would include diodes to create a single directional potential, to name one possibility among other required circuitry and support elements. By way of example to maintain drawing clarity, and not intended to be limiting, what is illustrated is a single set of winding, but other configurations of windings, winding direction, multiple windings, other configurations and various materials, wire or material gauge, proximity of the winging on the surface of the vessel, within the vessel or at the inner surface of the vessel, other considerations, and their combination all remain within the scope of the claims. Another placement example of the Converter is 1380 also placed horizontally in connection with OutPort 1352 and exhausting directly into the body of water. Under previous broad equations it is expected that the jet of water flowing from the turbine will penetrate and dissipate into the body of water at five times the radius of the exhaust. Although the previous examples show the turbine operating horizontally and vertically any orientation of the turbine is acceptable.

The Momentum Wheel 790 is a class of Elements on the Exchanger to be disclosed that provide secondary support to the Exchanger. The Exchanger is a type of water engine with a reciprocating piston action with intake and exhaust valves acting in a system and timing. A reciprocating engine is characterized by a discontinuous piston motion where momentum and mass are continually accelerated and decelerated as Elements change direction or positioning. A momentum wheel is an Element attached to the Exchanger and its Chambers, reciprocating Slider, InPort and OutPorts, and other systems of the Exchaner and timing to bring a continuous motion. The Momentum Wheel will assist the Exchanger in turning a reciprocating motion into effectively a continuous motion. The size of the Momentum Wheel will vary based upon the size of the Exchanger, use conditions, use load, preference, and other factors, and their combination. A second and related purpose of the Momentum Wheel will be to dampen vibration resulting from the reciprocal motion and other mechanical imbalances, if they were to exist. Only by way of example, not intended to be limiting, Momentum Wheel materials include metals, ceramics, carbons, minerals, cements and concretes, glasses, polymers, composites, elastomers, and their combination as may be needed by the variety of sizes and application of the Exchanger. Preferably the Momentum Wheel will be made of metal due to its size to weight ratio, among other factors. Stated previously that the Momentum Wheel is within a class of Elements of the Exchanger that provide secondary support. By way of example and without intent to be limiting, such secondary items are intended to be added and used based on Exchanger size, use conditions, materials, geographic location, use loads, other factors and their combination without stepping outside the primary claims of the Exchanger as described. Such secondary components will include pumps for setting initial internal hydrostatic pressure to prepare the Exchanger for the first Slider cycle and which could utilize manual or external power driven pump options. Sensors and other monitoring devices undoubtedly will also be integrated in the Exchanger without alteration of what is claimed with the Exchanger. As previously mentioned the drawings do not depict necessary infrastructure and supports for the Exchanger and which depend upon Exchanger size, use location, external Elements, and other factors and their combinations as a partial list. The attachment of tubing and concrete footings or other appropriate construction materials and practices should be recognized as having no influence on what is claimed. Not disclosed but necessary to the construction of the Exchanger would be fasteners, adhesives, sealants, and other interfacing connectors and integrity building Elements and their combinations depending upon Exchanger size, materials used, use conditions, use loads, and other factors not listed and their combination. The items and lists created in this disclosure, description, and discussion class are listed by way of example and not intended to be limiting in their materials, geometries, properties, and other characterizations.

A synchronizer is not illustrated but has been previously disclosed as an Element needed to coordinate the opening and closing of InPorts and OutPorts, as well as provide timing and coordination among other Exchanger Elements. A synchronizer can be composed of mechanical, electronic, electrical, other sources, and their combinations. Given the simplicity of the Exchanger to initiate and continue operations by simply the coordination of InPorts and OutPorts positioning, an ideal synchronizer would be mechanical linkages triggered by Slider movement at the end of the Chambers or beginning of the Chambers. Such a synchronizer may also utilize energy sources such as water movement and momentum as well as mechanical movement and momentum. The mechanical triggering and trigger device movement can itself open and close InPorts and OutPorts or command Actuators previously discussed. The statement of a mechanical system being ideal reflects the utility of the Exchanger and its simplicity and capacity to be a useful apparatus across the world among simple to sophisticated communities where a mechanical system would be readily understood. Equally ideal and preferred because of increased options would be electronic controls of timing, Actuators, gathering sensory information, and allowing communication to and from the Exchanger.

A microprocessor or computer and related controlling code and circuitry have been introduced for controlling Exchanger InPorts and OutPort timing, information gathering, two-way communication, data input and operational changes, other functions, and their combinations. The just describe list of microprocessor, controlling code, and circuitry function is by way of example and not intended to be limiting to those specific conditions. Although integral to the Exchanger the microprocessor or computer and circuitry to include wiring and connectors and other components have not been illustrated yet play no less an important role. These components have not been illustrated because they are well-established within the skill set of persons having ordinary skills in those arts. Those skill in control systems would know what is necessary and would acknowledge that different configurations would not step outside what is claimed. These controlling and connecting Elements are not the central focus of the Exchanger to have invented or improved upon microprocessors, computers, circuitry, sensors, coding, and other such required Elements for a functional Exchanger.

### DRAWING DESCRIPTION

FIG. 1 is a simplified and therefore a preferred configuration of the Exchanger as an application submerged in a body of water. The Exchanger is a simple device driven by the forces of gravity and the mass of water as combined and expressed as hydrostatic pressure. The simplicity of the Exchanger allows it to accommodate sources of hydrostatic pressure from stationary, turbulent, to flowing water, all of which can also establish a hydrostatic pressure. The principles of hydrostatic pressure cause there to be equal hydrostatic pressure in every direction to include laterally into the cylinder when open. A detailed description of the interrelationship among Exchanger Elements is given in the next paragraph because of the additional Elements required of that Exchanger configuration. Shown in this illustration is a cylinder that makes up what is called the Vessel 110 divided by the Slider 126 into Chamber 112 and Chamber 114. On both ends of the Vessel each Chamber has an InPort Framework 140 were Chamber 112 shows the InPort 142 to be closed by Actuator 170. By being closed and restraining external hydrostatic pressure from acting upon Chamber 112 a lower hydrostatic pressure within Chamber 112 is created. The InPort 144 of Chamber 114 is shown to be open and subject to the higher external hydrostatic pressure produced by the body of water. The differential of pressure with lower pressure in Chamber 112 and the higher pressure in Chamber 114 Slider 126 moves across and through Chamber 112. The water held in Chamber 112 is exhausted through open OutPort 150 controlled by Actuator 172. The exhausting water moving at a higher velocity to preserve the principle of continuity of fluid flow is exhausted into turbine 180 and out OutPort Return 154. The return cycle of the Slider occurs by synchronization and timing of OutPorts and InPorts opening and closing. Needed is InPort 144 to be close to create a low hydrostatic pressure in Chamber 114 causing Slider 126 to now move towards OutPort 152 which would open by Actuator 172 and allowing water to flow into the turbine 180 which exhausts water flow through OutPort Return 154. To minimize the directional change of Slider 126 this Exchanger configuration allows the Vessel 110 and associated Chambers to be extended to larger distances. That is Cutaway 199 allows Chamber 112 to be extended in the direction of InPort 142 at a distance. In like manner Cutaway 199 allows Chamber 114 to be extended at some distance in the direction of InPort 144 for a distance. The increased distance minimizes the number of reciprocal actions of Slider 126. The result of this Exchanger configuration is more constant Flow and Motion for Available Energy. The available distance is dependent upon the external hydrostatic pressure and other factors of Exchanger application as previously suggested. What will be found through the descriptions of the following illustrations is an Exchanger having a simple and robust structure adaptable to location sites and needs for use by communities worldwide where modest collections of water are available.

FIG. 1 being an apparatus for exchanging fluid to pressurized fluid flow and mechanical motion, comprising: a Vessel; and a Slider in the vessel; and two Chambers created by the Slider dividing the vessel; and an InPort with each Chamber that opens and closes to internal and external forces; and an OutPort with each Chamber that opens and closes to internal and external forces. The apparatus mentioned where in: an opened first Chamber InPort adopts external high hydrostatic pressure; and a closed second Chamber is filled but at low internal pressure isolated from external higher hydrostatic pressure. The apparatus mentioned wherein: the Slider moves from higher pressure to lower pressure; and the contents of the low pressure second Chamber are forced through the OutPort under higher first Chamber pressure. The apparatus mentioned where in: a Converter before the InPort accepts fluid flow; and a Converter after the OutPort accepts higher fluid flow. A Slider Link creates motion and Extractors make Available Energy acceptable by Converters in exchange for Useful Energy.

FIG. 2 Internal view of the Exchanger Vessel configured with a top Container suitable for submerged, semi-Submerged, and non-submerged applications. To convert available hydrostatic pressure to Available Energy the Exchanger is composed of a Vessel 210 which in this configuration is divided into three main sections by the Slider composed of Slider Surface 220, Slider Surface 222, and Slider Link 224 as previously discussed. The Slider divides the Vessel in two Chamber 212 with Slider Surface 220 at its lower most position in this illustration, and Chamber 214 with Slider Surface 222 at its uppermost position in this illustration. Integral to this Exchanger configuration is the Vessel Conduit 234 used by Slider Surface 220 and Slider Surface 222 to maintain substantially constant registry by way of Slider Link 224 using Pulley 230 and Axle 232 set. Slider Link 224 with Pulley 230 and Axle 232 together deliver a Flow, Motion, and their combinations or Energy Sites to both sides or one side of the Vessel for delivery of Available Energy. To set the stage for the operation of the Exchanger, note that InPort Framework 240 contains open InPort 242 servicing Chamber 212 and InPort 244 being closed and servicing Chamber 222. In this illustration with InPort 242 open Chamber 212 was subject to the external hydrostatic pressure above the Vessel and being directed to the InPort by Container 260. As a result Slider Surface 220 has been pushed to the lower part of Chamber 212 which action through Slider Link 224 has forced Slider Surface 222 upward and exhausting the water that had filled Chamber 214 through the OutPort 252. When Slider 220 was near or at the bottom of Chamber 212 then InPort 242 would have been closed and allowing Chamber 212 to take upon it a lower hydrostatic pressure defined by the height of the Chamber with InPort 242 closed and restraining the external hydrostatic pressure. In this position with the opening of InPort 244 there is newly exposed higher hydrostatic external pressure on Slider Surface 222 in the upward most position. Slider Surface 222 moves under the high hydrostatic pressure and transfers that movement through Slider Link 224 and to Slider Surface 220. Slider Surface 220 moves through Chamber 212 due to the contents being at a defined dimension and lower hydrostatic pressure and exhausting water in Chamber 212 through OutPort 250. At this point essentially a full cycle of the exhausting and loading of each Chamber has occurred. During this cycle integral to the operation of the Exchanger would be the facilitating opening and closing of OutPort 250 of Chamber 212 and OutPort 252 of Chamber 222 with both OutPorts joining into OutPort Return 254. In this illustration Actuator 272 would open or close each OutPort based upon the position of the InPort which is controlled by its own Actuator on the reverse side of the Exchanger and not shown. A unique characteristic of the OutPort is that based upon the speed of the Slider cycle the OutPort may remain open at all times during operation, and based upon the specific configuration of OutPort 254 to prevent interfering flow from one OutPort to the other. Another possibility is that the OutPort be cycled in an open and close manner based upon the open and close position of its associated InPort. For instance, when InPort 242 is open OutPort 250 is closed, yet OutPort 252 is open to exhaust the water being pushed from Chamber 214 as Slider Surface 222 moves upward with the InPort 244 being closed. This cycle of OutPorts to InPorts opening and closing relationship is repeated as Slider Surfaces move in a reciprocal fashion under the opening or closing of the respective InPorts. As a note, the orientation of the Vessel and the InPort and OutPort is of no consequence and may be downwardly pointed horizontally pointed or in this case vertically upward pointing and horizontally pointing. The only consideration would be if a Container 260 is an open container, then a vertical orientation as shown in this illustration would be needed or used with some type of conduit. Container 260 of the Exchanger is not restricted in its dimension or geometry in any manner but in this case begins with a matching interface with the InPorts and is divided partially in the center of the Container. This divider of the container may or may not be present. This type of container may be used in submerged, semi submerged, and non-submerged applications. Further, illustrated here is a Container 260 that narrows from a wider geometry to a narrower geometry. Under the continuity equation of fluid flow, the water under hydrostatic pressure in the larger geometry regions are accelerated through the narrower regions to maintain equilibrium of water volume flow through the InPorts and adds another source of energy. Container 260 is further expanded with Container Extension 262 of any dimension necessary. Lastly this illustration does not depict the inclusion of an Extractor or a Converter to transform Flow, Motion, and their combinations into an Available Energy such as electricity, pumping water, variable speed transmission, and other applications as has been discussed without these examples being a limit. The focus of this illustration has been on establishing a configuration that demonstrates how the principles of difference in hydrostatic pressure operate as a driving force for the Exchanger to extract Available Energy. Not including any Element on this or other illustration does not exclude its potential inclusion. This and other illustrations are examples designed to show preferred embodiments of the Exchanger as well as to teach its function, operation, simplicity, adaptability, and applicability as a source of energy to peoples and communities across the world. An extended discussion has been made of this FIG. 2 as a type of example of Exchanger configuration as it demonstrates a large amount of what is disclosed and claimed within other figures of Exchanger forms and Elements. Important is to see the simplicity yet ability to transform the power of significant hydrostatic pressure which is renewable and essentially locally infinite into Useful Energy.

FIG. 2 an apparatus for exchanging fluid to pressurized fluid flow and mechanical motion, comprising: a Vessel; and a Slider containing two Slider Surfaces held in position by a Slider Link that divides the Vessel into two Chambers; and Chambers with controllable internal environment; and an InPort at each end of the Chamber; and an OutPort at each end of the Chamber; and InPorts and OutPorts that open and close by Actuators. The apparatus previously disclosed where in: the Slider is substantially sealed; and the Slider is able to move throughout the Chamber. The apparatus previously disclosed where in: OutPorts are 0.8 or smaller than the diameter of the Chamber. The apparatus previously disclosed where in: the Chamber environment is controlled by the InPorts of which can be positioned by an Actuator from open to closed; and the Chamber environment is controlled by the OutPorts which can be positioned by an Actuator from open to closed. The apparatus previously disclosed where in: the InPorts may have any relationship to each other from opened to closed; and the OutPorts may have any relationship to each other from opened to closed; and the InPorts and OutPorts may have any relationship to each other from opened or closed. The apparatus previously disclosed where in: The OutPorts are linked to form one OutPort Return without interfering flow to the other OutPort. The apparatus previously disclosed where in: zero, one, or more Extractors or Converters receive fluid flow above the InPorts; and zero, one, or more Extractors or Converters receive the fluid flow out of the OutPorts. The apparatus previously disclosed where in: the Slider Link passes through a Vessel Conduit; and zero, one, or more Extractors or Converters connect through a Vessel Conduit to the Slider Link; and The apparatus previously disclosed where in: Extractor or Converter exchange Flow and Motion for Available Energy; and Converters exchange Available Energy for Useful Energy. The apparatus previously disclosed where in: a Container rests on top of the InPorts; and a Container of 1.2 times or more the height of the Chamber as the application requires. The apparatus previously disclosed where in: the fluid from the OutPorts returns to the Container.

FIG. 3 depicts four of numerous possible Slider Links that have been previously and fully discussed. In summary these illustrations depict Slider Links having the same Slider Surface 310 and Slider Surface 320 each with a means to substantially seal itself within its Chamber of use. A first specific illustration is Slider Link 330 which is simply a portion of a homogeneous ingot of a Slider containing both Slider Surfaces and the Slider Link within all are one integral component. Slider Link 340 represents a flexible solid or semi-solid incompressible material. Slider Link 350 shows an incompressible Slider Link composed of water, water with gel, water solution, or compressed gas which requires the Vessel Conduit and Slider Surfaces to be sealed. Slider Surface 360 represents a collection of plates composed of any one of a number of materials linked and held together with a flexible incompressible core. In this case the core is held in registry by the discs moving along the internal surface of the Chamber. Not included in this drawing but described in other figures are other forms of Slider Links. As previously mentioned the Slider Links are listed by way of example and are not intended to be limited to other configurations.

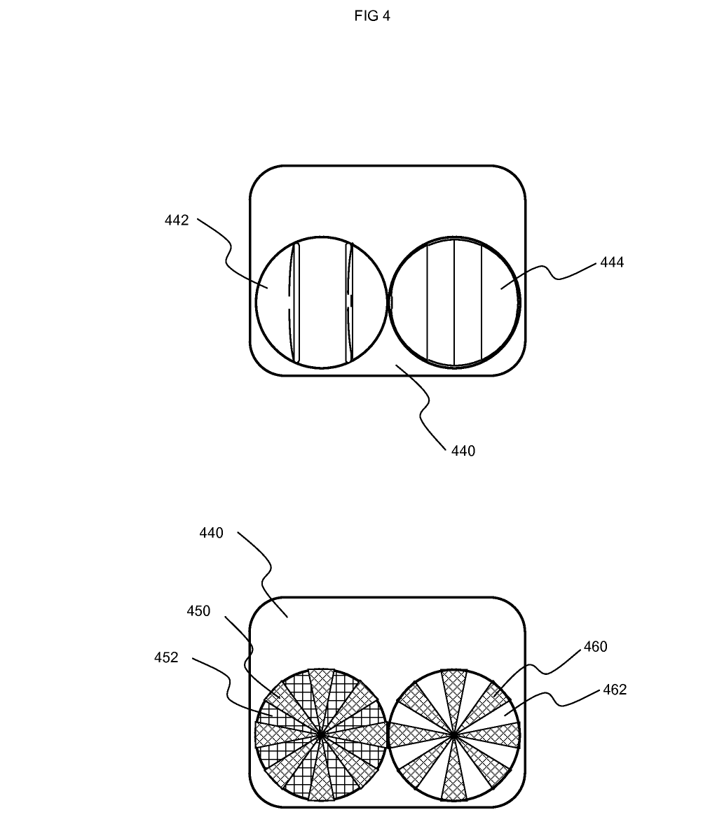

FIG. 4 illustrates two of many possibilities of InPort construction, and addressed in detail previously. In summary, there is InPort Framework 440 acting as a housing with control mechanisms which open InPort 442 and a closed InPort 444, as would be expected between the two Chambers. The construction of the InPort is a modified butterfly type valve with multiple gate plates instead of a single butterfly plate, although the traditional butterfly valve would also be serviceable. The InPort action shows the gate plates to be multiple smaller plates as this will ease opening and lifting them against the hydrostatic pressure. In the open position, the gate plates are then arranged parallel with the flow of water into the Chamber with minimal restriction to flow. The second InPort structure depiction starts with InPort Framework 440 and shows a horizontal opening and closing action with sectional disc 450 in the open position over structural elements of InPort Framework 440 leaving openings 452 for water flow into the Chamber. As expected the InPort for the opposing Chamber is closed restraining the hydrostatic pressure from acting on the contents of the Chamber and in such position sectional disc 460 are covering the openings of InPort and leaving InPort Framework 462 now being exposed creating a closed InPort. Alternatives to the InPorts illustrated in this drawing have been previously suggested to be without limitation.

FIG. 5 is an open view illustration representing an adaption of the left side view of FIG. 2 and provides additional understanding of the Exchanger. Illustrated is Vessel 510, showing the left Chamber 512 and a portion of the Vessel Conduit 534 divided by the Slider. The Slider Surface 520 connects through the Slider Link 524 down and across the Pulley 530 attached to Axle 532. The Axle 532 may extend to both sides of the Vessel as illustrated or to one or the other side of the Vessel as need dictates. As earlier explained Slider Surface 520 is at its lowest most position having been pushed downward because InPort Framework 540 with Actuator 570 had opened InPort 542 of Chamber 512 allowing higher external hydrostatic pressure to act on the Slider Surface 520 again pushing it downward. Through this motion there is a transferring of the higher pressure through the Slide Link 524 and against the opposing Slider Surface and Chamber not illustrated. OutPort 554 in this illustration may have one of two positions. One being remaining open as an alternative source for entrance of hydrostatic pressure and inlet water flow from the external water source in submerged or semi-submerged applications. OutPort 554 may also be closed when InPort 542 is open. The opening and closing of the OutPort 554 is accomplished by Actuator 572. Lastly a feature of this illustration of the Exchanger is the inclusion of Container 560 which allows this configuration to be applicable to submerged, semi-submerged and non-submerged applications where the Container in all cases can have any geometric shape or size but being no less than 1.2 times the height of the Chamber. Lastly this illustration does not depict the inclusion of a Converter or an Extractor to transform Flow, Motion, and their combination into an Available Energy for applications such as electrical generation, pumping water, driving a variable speed transmission, and other applications as has been discussed without example limitation. Again in this illustration the Container changes its shape having greater width at its opening and narrowing to a diameter similar to that of the InPort and in so doing creating an acceleration of flow through the InPort for added energy input into the Exchanger.

FIG. 6 illustrates the Exchanger now with the familiar form with changes of not having a Container and having a different Pulley 630 and Axle 632 Extractor system to draw out Available Energy and provide alignment of Slider Link 624 for registry of Slider Surface 620 and Slider Surface 622. The function of the Exchanger illustrated here is similar to that described in detail in FIG. 2. An Important consideration of the Exchanger illustrated here is that it is most likely applies in a submerged environment where the body of water itself acts as an infinite Container of water. In quick summary, illustrated is Vessel 610 with Chamber 612 and Chamber 614 divided by a Slider with Slider Surface 620 and 622 and having Slider Link 624. As a reminder the Slider is the total of components Slider Surface 620, Slider Surface 622, and Slider Link 624. The Slider also created Vessel Conduit 634 in which Slider Link 624 and other components operate. When looking at the construction of the Vessel and its Chambers a simple stop 616 is shown as one of many examples of controlling the travel distance of the Slider. The significance of the Exchanger and its impact on society is its simplicity to be utilized anywhere there is even a modest amount of water. The simplicity comes by the action of the Exchanger being initiated and infinitely operating by the cyclical opening and closing of the InPorts and OutPorts of the Exchanger. Again in this depiction, InPort Framework 640 holds open InPort 642 serving Chamber 612, with OutPort 650 elected to be closed by Actuator 672. Again the Actuator for opening and closing InPort 642 and InPort 643 is on the reserves side of the Exchanger. With open InPort 642, naturally the external high hydrostatic pressure has pushed Slider Surface 620, and acting through Slider Link 624 drives Slider Surface 622 through Chamber 614. During this motion OutPort 652 was open with water exhausting through it and OutPort Return 654 creating a useful result of water of higher velocity and pressure. The reverse cycle of InPort valve opening and closure and synchronized OutPort opening and closure with each respective Chamber creates a complete cycle that is continued with InPorts creating reciprocating higher external hydrostatic pressure and lower chamber hydrostatic pressure difference. The result is OutPort water velocity and water pressure for Available Energy as has previously been detailed in FIG. 2. Mention has been made of the different Pulley 630 and Axle 632 Extractor system employed in this illustration that creates Energy Sites on both or either side of the Vessel 610. By application requirement or preference, Pulley 630 has a greater radius from the Axle providing a different OutPort to Axle 632 as may be advantageous for the particular application. What is not illustrated is the attachment of a Converter to Axle 632. As previously defined the Exchanger Pulley 630 and Axle 632 Extractor transforms Flow, Motion, and their combinations into a Available Energy for application towards electricity, pumping water, variable speed transmission, and other applications as has been discussed without limit.

FIG. 7 illustrates an external view of a complete system suitable for submerged, semi-submerged or non-submerged applications. Looking at Vessel 710 having an Axle 732 centrally located at the bottom of the Vessel it is presumed that this illustration has the same larger Pulley and Axle system as described and illustrated in FIG. 6. Before we begin, this drawing is intended to illustrate and clarify Exchanger features previously discussed but now illustrated. The first is a type of common Vessel 710 which can accept different Containers. In this case the Container 760 is a long open structure whether a cylinder, square, or other geometry of Container and whether a single Container or a Container formed from two cylinders, tubes, other geometry, or their combinations. The Container description is made by way of example and not intended to be limiting as has previously been discussed. Further note with this illustration OutPort Return 754 is exhausting at the top of the Container where other illustrations have exhausts directly into a body of water or lower into the Container. All of these examples, not intended to be limited are configurations within what is claimed of the Exchanger. Another feature fully expressed is the observation of multiple Converters that may utilize the multiple Energy Sites on the Exchanger. The Converters are each numbered similarly but identified by the location. For instance Container 760 may accommodate one or more Converters 780 prior to water flowing into the InPorts either diverting all or some of the flowing water through the Converter. OutPort Return 754 also accommodates a Converter 780 with higher velocity water with that water returning to the top of the Container in this illustration. Axle 732 shows it providing for two utilities. One is Converter 780 not being a turbine but rather likely a traditional generator, a compressor, pump, mechanical transmission, or other device, and their combinations as have previously been defined. The force to accommodate one or more Converters is a function of the magnitude of hydrostatic pressure and the adaptable configurations of the Exchanger to provide rapid flow of water and positioned for a magnitude of hydrostatic pressure which readily accommodate the additional load and resistance added to the Exchanger system. An additional feature shown in this illustration is the Momentum Wheel 790 used as previously expounded upon to dampen possible vibration and homogenize the reciprocal motion of the Slider and Exchanger. Momentum Wheel 790 is an example of an Element of the Exchanger that may or may not be necessary depending upon the size of the Exchanger, location of use, load demands, and other application specific requirements. Further depicted simultaneously is Actuator 770 controlling the InPort Framework for opening and closing of the InPorts and Actuator 772 controlling the opening and closing of the OutPorts. This drawing again confirms the simplicity, adaptability, and utility of the Exchanger for global applications.

FIG. 8 shows internal views of additional Extractors of Flow, Motion, and their combination for the Exchanger to create an Available Energy. Previously shown was Pulley 230 with Axle 232 Extractors in a set providing for up to four Energy Sites. Also previously shown was the larger radius Pulley 530 and Axle 532 Extractor providing up to two Energy Sites. Illustrated in this drawing for context is a partial Vessel 810 with Vessel Conduit 834, and for reference Slider Surface 820. Shown is a Paddle Wheel 830 like Extractor running on Axle 832 again creating two Energy Sites with the Axle protruding out both sides or either side of the Vessel. This Extractor is powered by a Slider Link of an incompressible medium of water, fluid, compressed gas, or other mediums as discussed that flows past Paddle Wheel 830. Noteworthy, although not a necessary feature, illustrated is again the continuity of volume flow with the incompressible medium accelerating past a smaller Vessel Conduit opening generating additional Available Energy. In the second illustration of the diagram the Extractors are shown to be associated with Container 860. Illustrated are two Extractors showing Paddle Wheels 830 on opposite sides and in alignment with the other Extractor running on Axles 832 providing up to four Energy Sites. Of course its not necessary that the Extractors be oriented adjacent to each other but represents one possibility, albeit there is some favorable reason for this configuration to include continuity of volume flow as has been suggested throughout. These are examples only, and given without intent to be limiting Extractors acting upon Flow, Motion, or their combinations that is available for extraction from the Exchanger into Available Energy and Energy Sites for conversion to Useful Energy.

FIG. 9 shows somewhat of a continuation of the discussion in the previous paragraph by changing the subject from Extractors to Converters. In this case the Converters 980 do not require an Extractor to gain access to Flow, Motion, and their combination. As illustrated here is an internal view of the Exchanger using a turbine type Converter capable of extracting, converting, or extracting and converting simultaneously. In the first illustration for context the Vessel 910 is shown with Slider Surface 920 in its lowermost position and Vessel Conduit 934 connecting to Converter 980 depicted as a turbine. The Vessel Conduit 934 is adaptable to the needs of the Exchanger and its applications, Elements, and other purposes. As a turbine Converter 980 is connected to the Vessel Conduit 934 its intake and exhaust are from and into an adjacent Chamber. The configuration of the Vessel Conduit 934 amplifies the Available Energy by again use of the principle of continuity of volume flow. Also illustrated is an another in-line Converter 980 shown in the context of being integrated with Container 960 and placed above an InPort and operated by the flow of water under higher hydrostatic pressure into a Chamber. There are other illustrations of turbines located at different placement in other figures, but this discussion will limit to what is shown. Again, these are examples given without intent of restriction to other extractors, converters, or extractor and converter combinations to show the adaptability of the Exchanger for Converter location and use.

FIG. 10 shows another configuration of the Exchanger and the versatility of the operating principles and practices. Primary deviations from previous Exchanger configurations are the horizontal orientation with InPorts that facilitate a Container 1060 for use in submerged, semi-submerged, and non-submerged application. A benefit of this configuration, as previously discussed, are Cutaways 1099 of Chamber 1012, Chamber 1014, and Container 1060 allowing these Elements to extend to longer dimensions and distances to reduce the number of cycles or reciprocating motions of Slider 1026. Under this configuration and with appropriate hydrostatic pressure conditions, Slider 1026 will move for some distance with each directional movement. More specifically, this is an internal view showing a horizontal Vessel 1010 divided by Slider 1026 numbered to represent that it includes two Slider Surfaces and a Slider Link all as an integral unit. Slider 1026 divides the Vessel 1010 into Chamber 1012 and Chamber 1014 with similar function as previously discussed. Missing in this illustration from previously discussed configuration of the Exchanger is the Vessel Conduit and often associated Extractor used to draw Flow, Motion, or their combinations from Slider Links. In this illustration, the Exchanger is simplified to InPort 242 serving Chamber 1012 and InPort 244 serving Chamber 1014. As is expected another integral component to the Exchanger are the OutPorts. In this case the OutPorts are located at the ends of the Chambers near the InPorts but funneled to OutPort Return 1054. That is, OutPort 1050 with Chamber 1012 and OutPort 1052 with Chambers 1014. The operation of this Exchanger design is the same as that previously mentioned with a synchronization of InPorts and OutPorts to create higher and lower hydrostatic pressure differences between the Chambers such that the Slider moves to exhaust water from a lower hydrostatic pressure Chamber through a smaller OutPort at higher velocity and pressure to create Available Energy. Lastly depicted is Container 1060 allowing this configuration of the Exchanger to be applicable for submerged, semi-submerged, and non-submerged applications, as previously stated. As stated with the Vessel and lower Container sections, the top of Container 1060 is shown with Cutaway 1099 indicating that it can extend at greater distance vertically to tailor the hydrostatic pressure on the Exchanger. Other necessary components such as Actuators for operating the InPorts and OutPorts are simply located on the reverse and unseen side of the diagram. This drawing again reinforces the simplicity of the Exchanger in being composed of a simple number of Elements functioning under potentially significant hydrostatic pressure to create useful Flow, Motion, and their combinations to provide access to Available Energy. The simplicity again being adaptable to communities and cultures across the globe where there is the usual abundance of water.

FIG. 11 is an external adapted and left side view of FIG. 10. As a frame of reference first illustrated is the Vessel 1110 with Container 1160 on top separated by InPort Framework 1140 with InPorts driven by Actuator 1170. Also illustrated is OutPort 1150 with Actuator 1172 and OutPort Return 1154 directing water flow into a turbine Converter 1180 with water exhausting and returning to Chamber 1160 through OutPort Return 1154. Lastly Cutaway 1199 depicts that Container 1160 may extend for some distance above the Vessel. A larger message from this illustration again is the simplicity and adaptability of the Exchanger and its Elements for situational deployment for the benefit of communities wherever a viable water source exists.

The diagram will show a horizontal electrical generator. This would be a converter where slider (1026) would be a permanent magnet or contain a permanent magnet. The chamber (1010) would be surrounded by a coil. The motion of the magnet across the coils would create electricity through the coils, the same as a generator, in a horizontal motion instead of circular. The two leads would be connected each to two diodes which would cause the polarity at the end to be the same, regardless of the direction of the magnet. This will allow a constant polarity even with the reciprocal motion. It will not however create a steady or constant voltage as the flow will be less when the cycle changes from a left to right or right to left motion. I am sure that capacitors or batteries could be used to even out the voltage. I think that this would already be covered in the phrase “other device that creates Useful Energy” on page 11, so if you think it is not necessary we can leave it out.]

FIG. 12 is an internal view and adaptation of FIG. 10. Illustrated is Vessel 1210 without a Container and therefore most suitable to a submerged application. This illustration further indicates the simplicity and utility of the Exchanger now well understood. There is Vessel 1210 divided by Slider 1226 having to Slider Surfaces and a Slider Link integrated into a homogeneous unit, and creating Chamber 1212 and Chamber 1214. This establishes the basic structure of the Exchanger followed by InPort 1242 shown open and InPort 1244 as closed. The last key features are OutPort 1250 which is closed and OutPort 1254 which is open and exhausting water through the common OutPort Return 1254. The OutPorts are shown to each be receiving the exhaust of water from the Chamber emerging from the ends of the Chambers most closely associated with the InPorts. Only by way of preference and example, and not intended to be limited to this configuration, not depicted but well understood at this time is that OutPort Return 1254 would be connected to an Extractor or a Converter. All the needed Actuators are located on the opposite side of the Vessel and now well understood with controllers to time the opening and closing synchronization of the InPorts and OutPorts to create a functioning Exchanger as have been described previously in detail. Like all horizontal Exchanger configurations, a unique feature is the elimination or minimization of accumulated gravity or hydrostatic pressure against which a Slider would act in a vertical Chamber configuration. When Chamber height or distance is small compared to the external hydrostatic pressure this contribution is minimal anyway. However the horizontal Exchanger allows for large distances allowing the Slider to have a longer power strokes reducing the reciprocal character of the Exchanger. Converter 1280 includes a cover in this example over a coil or wire winding. Here Converter 1380 is depicted as a single winding, but as previously described include any winding design, number of windings, and proximity to the slider to produce and electrical potential voltage and current. To facilitate the production of electrical energy with motion is the Slider 1226 also containing a magnetic property. Additionally, as the electrical generator is integral to the Exchange, additional processing circuitry will be included to produce a useful electrical output. Not shown but an adaptation of this and other Exchangers only having water motion or flow a Momentum Wheel may still be attached with an Extractor to provide more consistent Available Energy.

FIG. 13 is a closed left side view of FIG. 12 with the alteration of a Container 1360 added. The Exchanger illustrated is capable of operation in submerged, semi-submerged, and non-submerged applications. The simplicity of the Exchanger is reinforced with a closed view showing the Vessel 1310 with InPort Framework 1340 and associated Actuator 1370 for opening and closing InPorts. Also shown is OutPort 1350 and Actuator 1372 to open and close the OutPorts. Further illustrated is OutPorts connected and exhausting water through OutPort Return 1354 connected to turbine 1380 which exhausts through final OutPort Return 1354. This configuration suggests a submerged application where OutPort return 1354 is exhausting the water back into the infinite reservoir in which the Exchanger is operating. The Container 1360 provides for Exchanger adaptability and adjustment with the conical design providing acceleration of flow even in this case while operating within an infinite body of water.

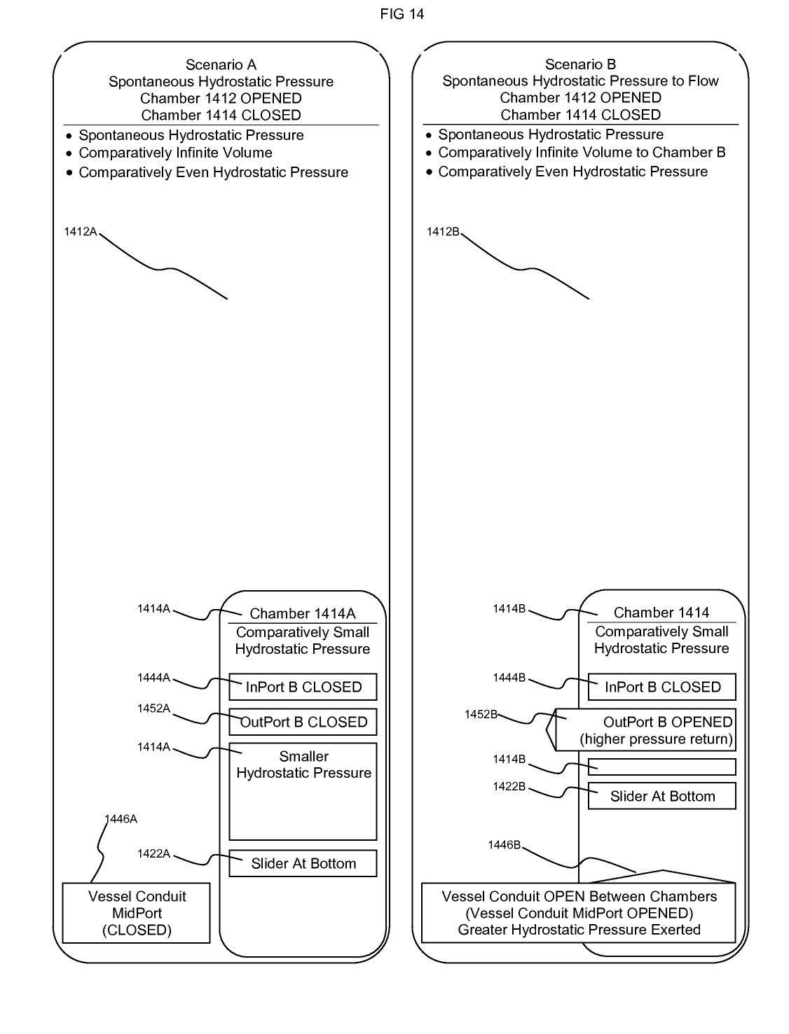

FIG. 14 is a block diagram used to emphasize the contrast between external hydrostatic pressure working against internal Chamber hydrostatic pressure to show the potential of the Exchanger. Illustrated are two scenarios. The first set of blocks titled scenario, A, includes Chamber 1412 which is opened to the external hydrostatic pressure and Chamber 1414 being closed to the external hydrostatic pressure forces. Under scenario A Chamber 1412 will be designated with an A or 1412A and is depicted as being encompassing of the entire body of water. This is the state of Chamber 1412A when its InPort (not shown) is open. Again the purpose of this block diagram is to show the significant hydrostatic pressure difference available to the Exchanger when the InPort stops restraining the external hydrostatic pressure and is opened and allows that external hydrostatic pressure force into the Chamber on which it acts on the Slider (not shown). In scenario A the external hydrostatic pressure now essentially being the entire body of water being held away from Chamber 1414A by a MidPort 1446A being closed or restraining the external hydrostatic pressure from Chamber 1414A. As the MidPort 1446A is closed, it is as if the InPort is closed or that the Slider is not moving and in either case the external higher hydrostatic pressure is not exerting pressure on the chamber 1414A. Also closed is InPort 1444A and OutPort 1452A creating in Chamber 1414A at lower hydrostatic pressure equivalent to the height of the Chamber. In scenario B Chamber 1412A remains open to external hydrostatic pressure for the InPort (not shown) is open and is therefore depicted as a large Vessel or essentially the external body of water. The hydrostatic pressure of Chamber 1412A is therefore equivalent to the whole body of water and acting equivalently throughout that body of water and now throughout the open Chamber 1412A. In scenario B MidPort 1446B is opened exposing Slider 1422B to higher hydrostatic pressure equivalent to the body of water. With this higher hydrostatic pressure the Slider 1422B move against the lower hydrostatic pressure create by the previously closed Chamber 1414A. To create this movement due to a lower hydrostatic pressure InPort 1444B remains closed holding back external hydrostatic pressure. The internal volume of Chamber 1414B is reduced by exhausting Chamber water contents through the open OutPort 1452B. The water exhausting through OutPort 1452B at higher velocity and higher pressure creates an Available Energy. Without intent of limitation, this illustration for simplicity focus on the principles of operation and to make clear the often significant difference in hydrostatic pressure between the chambers. As such, an Extractor nor a Converter were included in the Block Diagram, but the exhausted water is placed directly back into the body of water. The exhausting water overcomes the external hydrostatic pressure due to its increased flow velocity, increased pressure, and fluid momentum that projects out of the OutPort water stream to a distance of ⅕ the radius of the OutPort upon which it is dissipates into the body of water. It has been seen that the exhausting of water can occur at various locations whether within or above any water line. The purpose of this Bock Diagram again is to provide an alternative view of the of Elements, operation, and principles of the Exchanger.

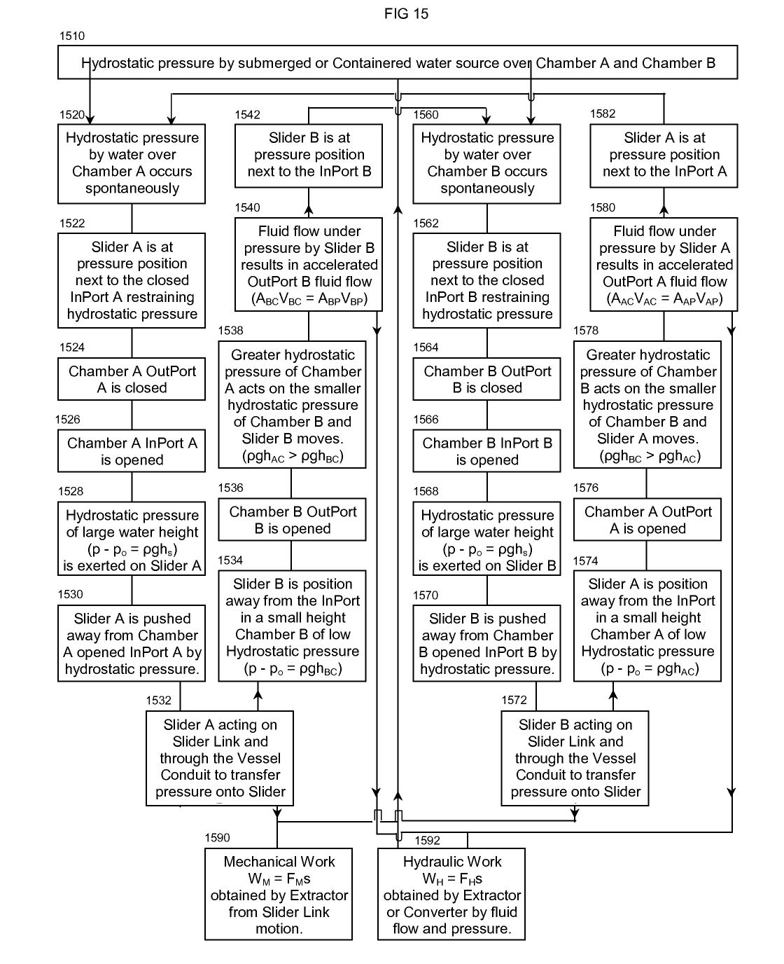

FIG. 15 is a flow chart of the method and steps of operation of the Exchanger. This flowchart relates to an Exchanger having a Vessel Conduit that connects the two Chambers, such as FIG. 2. Step 1510 establishes the hydrostatic pressure of the system by submersion or by a Container over Chamber A and Chamber B as described in this flowchart. Step 1520 recognizes that hydrostatic pressure is created spontaneously any time there is a contained body of water. Step 1522 is an initial condition placing Slider Surface A that we will refer to as Slider A at the position next to the closed InPort of Chamber A which is restraining hydrostatic pressure. Step 1524 acknowledges the initial condition that OutPort A of Chamber A is closed. To initiate the operation of the Exchanger step 1526 indicates Chamber A InPort A is open resulting in step 1528 with hydrostatic pressure of the larger water height of either a Container or body of water is now exerted on Slider A. The result is step 1532 with Slider A now acting against Slider Link through the Vessel Conduit which acts to transfer hydrostatic pressure to Slider B. The greater pressure now coming through the Slider Link acts on step 1534 with Slider B positioned away from the Chamber InPort in a small height Chamber of low hydrostatic pressure. With the immediate action of step 1536 with Chamber B OutPort B being opened step 1538 begins the transformation of hydrostatic pressure resulting from at least a local pool of stationary water into step 1538 where that greater hydrostatic pressure coming from Chamber A begins to act on the smaller hydrostatic pressure of Chamber B through the Slider Link and the Slider B begins to move. Step 1540 results in fluid flow under the pressure of Slider B accelerating through OutPort B under principles of continuity of volume flow. Ultimately step 1542 has Slider B reaching the end of the Chamber next InPort B. Although sequentially shown and discussed, steps 1520 through steps 1542 would occur near simultaneously. In summary, thus far the flowchart has outlined the steps and process of taking hydrostatic pressure from a volume of water and opening Chamber A to its influences which pushes on Slider A and ultimately upon Slider B through the Slider Link. With the opening of the OutPort B the water of Chamber B begins to flow at an accelerated velocity through the OutPort B by creating higher velocity and higher pressure or transferring stationary water into a useful water property. What is needed is to return the Exchanger back to its original starting position by repeating the process now initiating in and acting through Chamber B. The process of hydrostatic pressure acting upon Chamber B begins with step 1560 were again there's a high pressure and spontaneous force available to the Chamber. Step 1562 has Slider B as previously mentioned position next to the closed InPort B which is restraining the external hydrostatic pressure. Also closed is shown in step 1564 is Chamber B OutPort B. To initiate another power stroke in the Exchanger step 1556 shows that Chamber B InPort B is opened. Step 1568 follows by recognizing the hydrostatic pressure of the large water height from the external body of water or a Container is now exerting larger hydrostatic pressure on Slider B. Step 1570 has Slider B pushed away from Chamber B with the opening of InPort B and allowing the affect of the higher external hydrostatic pressure. Naturally as shown in step 1572 Slider B begins to move and exert the higher hydrostatic pressure onto the incompressible Slide Link through the Vessel Conduit and onto Slider A. Under step 1574 Slider A which was just moments earlier positioned away from the InPort A with lower hydrostatic pressure due to smaller Chamber A height. Step 1576 opens OutPort A of Chamber A and the difference in pressure initiates step 1578 and the movement of Slider A Chamber A. Water flows through OutPort A with step 1580 at a greater velocity and pressure than that acting on Chamber B and Chamber A by way of the Slider Link. Ultimately step 1582 occurs with Slider a positioning itself to InPort A of Chamber A and Chamber A water exhausted at a higher velocity and pressure creating a Available Energy. Another half cycle has occurred in exchanging water in a stationary or turbulent volume form from a body of water of a Container water driven by the spontaneous presence of hydrostatic pressure. Although sequentially shown and discussed, steps 1520 through steps 1542 would occur near simultaneously. Taking steps 1510 through 1582 and back to 1520 under 1510 a full reciprocal cycle of Slider movement has occurred through which stationary water that is naturally occurring and abundantly present provides a sustainable infinite source of hydrostatic pressure energy through the process and method steps of the Exchanger to produce Flow and Motion. This Available Energy of the Exchanger is shown to be captured in step 1590 through the movement of the Slider Link of step 1532 and step 1572. An Extractor harnesses the physical motion of the Slider Link and transforms it into Available Energy at an Energy Site that provides access for a Converter to produce desired energy product and result. The Exchanger provides additional sources of Available Energy as shown with step 1592 related to flow or hydraulic work with fluid dynamic properties available to Extractors to create an Energy Site or flow available directly by Convertors to Useful Energy. The flowchart of the Exchanger having two Chambers connected by a Vessel Conduit shows the simplicity of the Exchanger with a limited number of other robust Elements to accept natural, spontaneous, and effectively infinite source of water and its associated hydrostatic pressure and create a useful, controllable, and scalable energy access.

FIG. 15 provides evidence for the method of the Exchanger for exchanging fluid to pressurized fluid flow and mechanical motion, the method comprising: a Vessel exposed to hydrostatic pressure difference; and the hydrostatic pressure being present by the Vessel being submerged in a body of fluid or effectively submerged by a Container of fluid; and the InPorts and OutPorts of the Chambers being closed; and a first Chamber with a Slider Surface positioned adjacent to the closed InPort restraining the hydrostatic pressure from the Slider; and a second Chamber filled with fluid; and the Slider Surface of the second Chamber being positions distant from the Chamber OutPort; and the first Chamber InPort being opened by an Actuator and exposing hydrostatic pressure on the Slider; and the second Chamber InPort remains closed creating a lower hydrostatic Chamber pressure; and the second Chamber OutPort being opened by an Actuator; and the second Chamber Slider Surface is linked to the first Chamber Slider Surface and they move from the higher hydrostatic Chamber pressure of first Chamber to the lower hydrostatic Chamber pressure of the second Chamber at the same rate; and the Slider Surface of the second Chamber creates fluid flow as it moves towards the second Chamber closed InPort; and the fluid flow from the second Chamber through the smaller OutPort creates a greater velocity and greater other physical properties than the fluid in the first Chamber; and fluid flow before the InPort of the first Chamber passes through zero, one, or more Converters; and zero, one, or more Converters connected to the movement of the link between the Slider Surfaces; and fluid flow through the OutPort of the second Chamber passes through zero, one, or more Converters; and Converters can be electric generators, compressors, pumps, mechanical transmissions other mechanical or fluid movement to energy adapters and utilizers; and fluid flowing out of a Converter prior to the InPort is used to move the Slider Surface of the first Chamber; and fluid flow out of a Converter after the OutPort is delivered into the body of fluid or fluid in the Container; and until the Sliders reaches the ends of the Chambers; and the first Chamber is full of fluid with the Slider Surface distant from the first Chamber with the InPort closed by a Actuator; and the second Chamber is empty of fluid with the Slider Surface adjacent to the second Chamber InPort opened by an Actuator; and the OutPort of the second Chamber is closed by an Actuator; and the OutPort of the first Chamber is opened by an Actuator; and the Slider of the second Chamber moving away from the higher second Chamber hydrostatic pressure and forcing the linked Slider Surface of the first Chamber to move towards the open OutPort of the first Chamber creating fluid flow; and the fluid flow from the first Chamber through the smaller OutPort creates a greater velocity and greater other physical properties than the fluid in the second Chamber; and Extractors and Converter take the Available Energy from Flow, Motion, and their combination and transform it to Useful Energy; and until the first Chamber is empty of its fluid; and a complete cycle of transition of fluid to flowing fluid with pressure is complete; and the cycle of orchestrated positioning of InPorts and OutPorts to create hydrostatic difference in pressure is repeated until InPorts or OutPorts are position to equalize hydrostatic pressure.

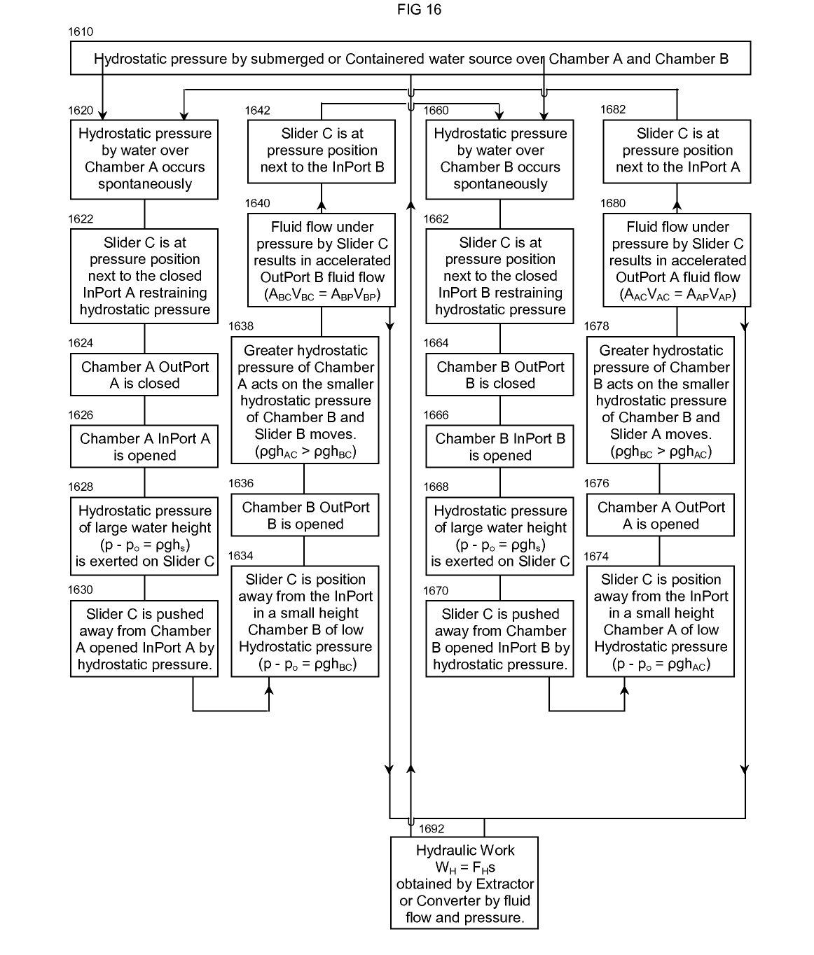

FIG. 16 is also a flowchart of an Exchanger configured in this case having two Chambers without a Vessel Conduit such as FIG. 1. The steps and principles described in this flowchart are similar to those described in detail in flowchart of FIG. 15. As such for explanation of the steps methods and process of flowchart in FIG. 16 reference will be made to the explanation of flowchart of FIG. 15. The following alterations to the explanation of flowchart in FIG. 15 will be made. The first is an alteration with the Slider. Rather than referring to Slider Surface A as Slider A and Slider Surface B as Slider B, the Slider as shown in FIG. 1, or Slider 126 is represented more as homogeneous disc incorporating Slider surface A, Slider Link, and Slider Surface B all referred to as Slider 126. FIG. 16 however shows the same Slider 126 and refers to it as Slider C. A second alteration is simply recognizing that there is no Vessel Conduit under the configuration described by the flowchart of FIG. 16, as seen in FIG. 1. Essentially the Vessel Conduit has been compressed to be equivalent to the homogeneous and integrated Slider Link, as just explained. As such, FIG. 16 shows a simplified flowchart with the removal of the mechanical based Extractors as there is no Vessel Conduit mechanism or fluid motion. FIG. 16 does show the presence of hydraulic work or the creation of an Available Energy using an Extractor or Converter in connection with fluid motion, flow, pressure, or their combination.

FIG. 16 provides a method for exchanging fluid to pressurized fluid flow and mechanical motion, the method comprising: a Vessel with two Chambers exposed to hydrostatic pressure difference; and a first Chamber is subjected to higher hydrostatic pressure while an opposing second Chamber is subjected to a lower hydrostatic pressure; and a Slider Surface in the first Chamber and a Slider in the second Chamber are linked and subjected to the higher hydrostatic pressure and the Slider Surfaces and link movement and fluid flow toward the lower hydrostatic Chamber pressure until the cycle ceases, and the flow through the smaller OutPort increases the flow velocity into a form of Available Energy accepted by Converters to exchange it for Useful Energy; and the second Chamber is now subjected to a higher hydrostatic pressure while the opposing first Chamber is subjected to a lower hydrostatic pressure; and the cycle of Slider Surfaces and link movement and fluid flow from a higher hydrostatic Chamber pressure to a lower hydrostatic Chamber pressure repeats until equilibrium of forces is reached; and the flow through the smaller OutPort increases the flow velocity into a form of Available Energy for Converters to exchange it for Available Energy; and where a Slider Link creates motion Extractors make Available Energy accepted by Converters to exchange for Useful Energy.

A complete and thorough disclosure of the Exchanger and its simple set of Elements and examples of their range of configurations have been made. Its principles of operation have been disclosed in detail and inferred through the discussion and figures. The simplicity, adaptability, and utility of the Exchanger has been well established as a viable apparatus for creating Available Energy. Given most populations are near coastal and other water locations and the simplicity of a man-made structure suitable to operate the Exchanger are evident, the Exchanger places a new and abundant source of energy in reach of the majority of communities worldwide. All alternative energy sources to date suffer from providing only marginal and unreliable energy quantities. The simplicity of the Exchanger allows for its scalability and use in combination with a plurality of Exchangers drawing on reliable, natural, sustainable, spontaneously available and limitless sources of hydrostatic pressure derived energy. This energy is converted in an environmentally benign way to provide energy production reaching magnitudes and availability significant to what communities and societies have available to them today. The Importance of protecting the totality of the Exchanger could not be more important to mankind.

Given the thorough details and multiple configurations disclosed of the Exchanger, there is no example or discussion presented that is intended to be limiting, but given by way of requirement and to express the breadth and scope of the Exchange to fulfill upon what is claimed. Persons having ordinary skill in the art appreciate that the alterations given and other implied alterations remain readily within what is claimed. Further, persons having ordinary skill in the art readily acknowledged: (1) the principles of hydrostatic pressure and other general scientific principles provide for an Exchanger that properly organizes the cooperation of a simple set of Elements of two Chambers, a Slider, InPorts and OutPorts and their Actuators, control systems, electively a Container, Flow and Motion Extractors to provide Available Energy. (2) Exchanger structure is not strictly limited to a particularly geometry of the Vessel, Chambers, Slider, and other components except that they integrate, and as such the Exchanger and all its Elements are inclusive of all geometries that produce what is claimed. (3) That Actuators and Converters necessary are available by market sources and that their particular specification may vary based upon location, use conditions, purpose and need, and other application considerations. (4) Other Elements and components of the Exchanger not specifically detail or possibly not even mentioned are encompassed, such as mechanical or electronic controllers among other Elements, but minimized to maintain disclosure clarity, but are an intuitive and inclusive with of the Exchanger from its container, to Vessel, and through all needed elements, and to required infrastructure are inclusive as to what is claimed.

While the invention has been described with reference to the preferred embodiment thereof, it will be appreciated by people having ordinary skill in the arts that modifications can be made to the structure and elements of the invention without departing from the spirit and scope of the invention as a whole.

What is claimed:

1. Apparatus for exchanging fluid to pressurized fluid flow and mechanical motion, comprising:
a Vessel; and
a Slider containing two Slider Surfaces held in position by a Slider Link that divides the Vessel into two Chambers; and
Chambers with controllable internal environment; and
an InPort at each end of the Chamber; and
an OutPort at each end of the Chamber; and
InPorts and OutPorts that open and close by Actuators.

2. The apparatus of claim 1 where in:
the Slider is substantially sealed; and
the Slider is able to move throughout the Chamber.

3. The apparatus of claim 1 where in:
OutPorts are 0.8 or smaller than the diameter of the Chamber.

4. The apparatus of claim 1 where in:
the Chamber environment is controlled control by the InPorts can be positioned by an Actuator from open to closed; and
the Chamber environment is controlled control by the OutPorts can be positioned by an Actuator from open to closed.

5. The apparatus of claim 4 where in:
the InPorts may have any relationship to each other from opened to closed; and
the OutPorts may have any relationship to each other from opened to closed; and
the InPorts and OutPorts may have any relationship to each other from opened or closed.

6. The apparatus of claim 4 where in:
The OutPorts are linked to form one OutPort Return.

7. The apparatus of claim 4 or claim 6 where in:
zero, one, or more Extractors or Converters receive fluid flow above the InPorts; and
zero, one, or more Extractors or Converters receive the fluid flow out of the OutPorts.

8. The apparatus of claim 1 where in:
the Slider Link passes through a Vessel Conduit; and
zero, one, or more Extractors or Converters connect through a Vessel Conduit to the Slider Link; and

[symbol]

9. The apparatus of claim 7 or claim 8 where in:
Extractor exchange Flow and Motion for Available Energy; and
Converters exchange Available Energy for Useful Energy.

10. The apparatus of claim 1 where in:
a Container rests on top of the InPorts; and
a Container of 1.2 times or more the height of the Chamber.

11. The apparatus of claim 4, 5, 6, or 7 where in:
the fluid from the OutPorts returns to the Container.

12. A method for exchanging fluid to pressurized fluid flow and mechanical motion, the method comprising:
a Vessel exposed to hydrostatic pressure difference; and
the hydrostatic pressure being present by the Vessel being submerged in a body of fluid or effectively submerged by a Container of fluid; and
the InPorts and OutPorts of the Chambers being closed; and
a first Chamber with a Slider Surface positioned adjacent to the closed InPort restraining the hydrostatic pressure from the Slider; and
a second Chamber filled with fluid; and
the Slider Surface of the second Chamber being positions distant from the Chamber OutPort; and
the first Chamber InPort being opened by an Actuator and exposing hydrostatic pressure on the Slider; and
the second Chamber InPort remains closed creating a lower hydrostatic Chamber pressure; and
the second Chamber OutPort being opened by an Actuator; and
the second Chamber Slider Surface is linked to the first Chamber Slider Surface and they move from the higher hydrostatic Chamber pressure of first Chamber to the lower hydrostatic Chamber pressure of the second Chamber at the same rate; and
the Slider Surface of the second Chamber creates fluid flow as it moves towards the second Chamber closed InPort; and
the fluid flow from the second Chamber through the smaller OutPort creates a greater velocity and greater other physical properties than the fluid in the first Chamber; and
fluid flow before the InPort of the first Chamber passes through zero, one, or more Converters; and
zero, one, or more Converters connected to the movement of the link between the Slider Surfaces; and
fluid flow through the OutPort of the second Chamber passes through zero, one, or more Converters; and
Converters can be electric generators, compressors, pumps, mechanical transmissions other mechanical or fluid movement to energy adapters and utilizers; and
fluid flowing out of a Converter prior to the InPort is used to move the Slider Surface of the first Chamber; and
fluid flow out of a Converter after the OutPort is delivered into the body of fluid or fluid in the Container; and
until the Sliders reaches the ends of the Chambers; and
the first Chamber is full of fluid with the Slider Surface distant from the first Chamber with the InPort closed by a Actuator; and
the second Chamber is empty of fluid with the Slider Surface adjacent to the second Chamber InPort opened by an Actuator; and
the OutPort of the second Chamber is closed by an Actuator; and
the OutPort of the first Chamber is opened by an Actuator; and
the Slider of the second Chamber moving away from the higher second Chamber hydrostatic pressure and forcing the linked Slider Surface of the first Chamber to move towards the open OutPort of the first Chamber creating fluid flow; and
the fluid flow from the first Chamber through the smaller OutPort creates a greater velocity and greater other physical properties than the fluid in the second Chamber; and
Extractors and Converter take the Available Energy from Flow, Motion, and their combination and transform it to Useful Energy; and
until the first Chamber is empty of its fluid; and
a complete cycle of transition of fluid to flowing fluid with pressure is complete; and
the cycle of orchestrated positioning of InPorts and OutPorts to create hydrostatic difference in pressure is repeated until InPorts or OutPorts are position to equalize hydrostatic pressure.

13. A method for exchanging fluid to pressurized fluid flow and mechanical motion, the method comprising:
a Vessel with two Chambers exposed to hydrostatic pressure difference; and
a first Chamber is subjected to higher hydrostatic pressure while an opposing second Chamber is subjected to a lower hydrostatic pressure; and
a Slider Surface in the first Chamber and a Slider in the second Chamber are linked and subjected to the higher hydrostatic pressure and the Slider Surfaces and link movement and fluid flow toward the lower hydrostatic Chamber pressure until the cycle ceases, and
the flow through the smaller OutPort increases the flow velocity into a form of Available Energy accepted by Converters to exchange it for Available Energy; and
the second Chamber is now subjected to a higher hydrostatic pressure while the opposing first Chamber is subjected to a lower hydrostatic pressure; and
the cycle of Slider Surfaces and link movement and fluid flow from a higher hydrostatic Chamber pressure to a lower hydrostatic Chamber pressure repeats until equilibrium of forces is reached; and
the flow through the smaller OutPort increases the flow velocity into a form of Available Energy for Converters to exchange it for Useful Energy; and
where a Slider Link creates motion Extractors make Available Energy accepted by Converters to exchange for Available Energy.

14. An apparatus for exchanging fluid to pressurized fluid flow and mechanical motion, comprising:
a Vessel; and
a Slider in the vessel; and
two Chambers created by the Slider dividing the vessel; and
an InPort with each Chamber that opens and closes to internal and external forces; and
an OutPort with each Chamber that opens and closes to internal and external forces.

15. The apparatus of claim 12 where in:
an opened first Chamber InPort adopts external high hydrostatic pressure; and
a closed second Chamber is filled but at low internal pressure isolated from external higher hydrostatic pressure.

16. The apparatus of claim 13 wherein:
the Slider moves from higher pressure to lower pressure; and
the contents of the low pressure second Chamber are forced through the OutPort under higher first Chamber pressure.

17. The apparatus of claim 14 where in:
a Converter before the InPort accepts fluid flow; and
a Converter after the OutPort accepts higher fluid flow.

18. The apparatus of claim 14 where in
a Slider Link creates motion Extractors make Available Energy accepted by Converters to exchange for Useful Energy.
